(19) United States
(12) Patent Application Publication
(10) Pub. No.: US 2021/0291480 A1
(43) Pub. Date: Sep. 23, 2021

(54) INFLATABLE CELLULAR CUSHIONING ARTICLE WITH ENHANCED PERFORMANCE PROPERTIES

(71) Applicant: Sealed Air Corporation (US), Charlotte, NC (US)

(72) Inventors: Slawomir Opuszko, McAdenville, NC (US); Gary J. Hayes, Charlotte, NC (US); Janet W. Rivett, Charlotte, NC (US); Richie L. Burke, Woodruff, SC (US); Samantha Hebda, Charlotte, NC (US); Kyle D. Dunno, Charlotte, NC (US)

(21) Appl. No.: 17/262,019

(22) PCT Filed: Jul. 25, 2019
(86) PCT No.: PCT/US2019/043340

§ 371 Date: Jan. 21, 2021

Related U.S. Application Data
(60) Provisional application No. 62/703,176, filed on Jul. 25, 2018.

(51) Int. Cl. B32B 3/12; C08L 23/06; B32B 27/08; B32B 27/32; B65D 81/03; B65D 65/40; B65D 81/02; B29C 48/00; B29C 48/08; B29C 48/88

(52) U.S. Cl. CPC B32B 3/12; B29L 2031/712; B32B 27/08; B32B 27/32; B65D 81/03; B65D 65/40; B65D 65/44; B29C 48/0021; B29C 48/08; B29C 48/914; B32B 2307/7244; B32B 2250/242; B32B 2272/00; B32B 2307/31; B32B 2250/05; B32B 2307/56; B32B 2553/02; C08L 23/06

(57) ABSTRACT

An inflatable cellular cushioning article has a plurality of inflatable chambers with each chamber comprising a plurality of inflatable cells connected in series with one another by connecting channels. The article is made from a first multilayer film sealed to itself or to a second film. The first film comprises a plurality of microlayers. At least 50 percent of the microlayers comprise a polymer selected from the group consisting of ethylene homopolymer, ethylene copolymer, propylene homopolymer, and propylene copolymer.

This application claims the benefit of U.S. Provisional Application No. 62/703,176 filed Jul. 25, 2018, which is incorporated herein in its entirety by reference.

The presently disclosed subject matter relates to inflatable articles suitable for use as cushioning articles and as dunnage and/or void fill, particularly for use in packaging applications.

### BACKGROUND

Air-cellular cushioning articles have been in use for some time. Conventional cushion materials include thermoformed sealed laminate articles such as BUBBLE WRAP® cushioning material. However, it is also known to prepare laminated inflatable articles which can be shipped to a packer uninflated, and inflated immediately before use. Such inflatable articles are typically made from two heat sealable films which are fused together in discrete areas to form one or more inflatable chambers. However, the inflatable articles utilize a considerable amount of thermoplastic material, and are of limited burst strength. It would be desirable to utilize less thermoplastic material and/or provide an inflatable article which exhibits improved burst strength.

### SUMMARY

The inflatable article disclosed herein utilizes one or more films containing microlayers, and has been found to provide one or more improved performance properties compared with an otherwise identical inflatable article made from one or more films lacking microlayers. In some embodiments disclosed herein, the inflatable article made from two multilayer films each having microlayers provides enhanced burst strength versus the burst strength of comparative inflatable articles made from films that were identical except lacking the microlayer structure. In some embodiments herein, inflatable articles made from multilayer films with microlayers provided enhanced survival at altitude versus the survival at altitude of comparative inflatable articles made from films that were identical except lacking the microlayer structure. In some embodiments herein, it has been shown that inflatable articles made from multilayer films with microlayers were made from films capable of greater elongation, i.e., greater toughness, versus comparative inflatable articles made from comparative films that were identical except lacking the microlayer structure. In some embodiments herein, inflatable articles made from multilayer films with microlayers provided enhanced compressive strength versus the compressive strength of comparative inflatable articles made from films that were identical except lacking the microlayer structure.

A first aspect is directed to an inflatable cellular cushioning article having a plurality of inflatable chambers with each chamber comprising a plurality of inflatable cells connected in series with one another by connecting channels, the article being made from a first multilayer film sealed to itself or a second film, wherein the first film comprises a plurality of microlayers, with at least 50 percent of the microlayers comprising a polymer selected from the group consisting of ethylene homopolymer, ethylene copolymer, propylene homopolymer, and propylene copolymer.

In an embodiment, the first multilayer film further comprises an alpha section containing a first subset of the plurality of microlayers, and a beta section containing a second subset of the plurality of microlayers, wherein at least 50% of the microlayers in the alpha section comprise a polymer selected from the group consisting of ethylene homopolymer, ethylene copolymer, propylene homopolymer, and propylene copolymer, and at least 50% of the microlayers in the beta section comprise a polymer selected from the group consisting of ethylene homopolymer, ethylene copolymer, propylene homopolymer, and propylene copolymer.

In an embodiment, 100% of the microlayers in the alpha section comprise a polymer selected from the group consisting of ethylene homopolymer, ethylene copolymer, propylene homopolymer, and propylene copolymer, and 100% of the microlayers in the beta section comprise a polymer selected from the group consisting of ethylene homopolymer, ethylene copolymer, propylene homopolymer, and propylene copolymer.

In an embodiment, the first multilayer film is sealed to the second film, and the second film is a second multilayer film also comprising a plurality of microlayers with at least 50% of the microlayers in the second film comprising a polymer selected from the group consisting of ethylene homopolymer, ethylene copolymer, propylene homopolymer, and propylene copolymer.

In an embodiment, the second multilayer film further comprises a gamma section containing a first subset of the plurality of microlayers in the second film, and a delta section containing a second subset of the plurality of microlayers in the second film, with at least 50% of the microlayers in the gamma section comprising a polymer selected from the group consisting of ethylene homopolymer, ethylene copolymer, propylene homopolymer, and propylene copolymer, and at least 50% of the microlayers in the delta section comprising a polymer selected from the group consisting of ethylene homopolymer, ethylene copolymer, propylene homopolymer, and propylene copolymer.

In an embodiment, 100% of the microlayers in the gamma section comprise a polymer selected from the group consisting of ethylene homopolymer, ethylene copolymer, propylene homopolymer, and propylene copolymer, and 100% of the microlayers in the delta section comprise a polymer selected from the group consisting of ethylene homopolymer, ethylene copolymer, propylene homopolymer, and propylene copolymer.

In an embodiment, the first film comprises from 5 to 200 microlayers and the second film comprises from 5 to 200 microlayers.

In an embodiment, each of the microlayers in the alpha section has an average thickness of from 0.001 to 0.1 mil and the alpha section has a total thickness of from 0.05 mil to 0.5 mil, and each of the microlayers in the beta section has an average thickness of from 0.001 to 0.1 mils and the alpha section has a total thickness of from 0.05 mil to 0.5 mil.

In an embodiment, the alpha section and the beta section each have from 5 to 50 microlayers and together make up from 20 to 80 wt % of the first film (based on total film weight basis, i.e., “tfb”), and the gamma section and delta sections each have from 5 to 50 microlayers and together make up from 20 to 80 wt % of the second film (tfb), and each of the microlayers in the alpha, beta, gamma, and delta sections comprises at least one member selected from the group consisting of homogeneous ethylene/alpha-olefin copolymer, low density polyethylene, linear low density polyethylene, very low density polyethylene, ultra low density polyethylene, medium density polyethylene, high density polyethylene, and ethylene/norbornene copolymer.

In an embodiment, the alpha section and the beta section each have from 10 to 30 microlayers and together make up from 30 wt % to 75 wt % of the first film, and the gamma section and the delta section each have from 10 to 30 microlayers and together make up from 30 wt % to 75 wt % of the second film.

In an embodiment, the alpha section and the beta section each have from 12 to 25 microlayers and together make up from 40 wt % to 70 wt % of the first film, and the gamma section and the delta section each have from 12 to 25 microlayers and together make up from 40 wt % to 70 wt % of the second film.

In an embodiment, the alpha section and the beta section each have from 12 to 20 microlayers and together make up from 50 wt % to 70 wt % of the first film, and the gamma section and the delta section each have from 12 to 20 microlayers and together make up from 50 to 70 wt % of the second film.

In an embodiment, the alpha section comprises a microlayer which is an outer film layer, and at least a portion of the alpha section serves as a seal layer.

In an embodiment, the beta section comprises a microlayer which is an outer film layer, and at least a portion of the beta section serves as an abuse layer.

In an embodiment, the first film further comprises a outer seal layer, an outer abuse layer, an oxygen barrier layer between the outer seal layer and the outer abuse layer, a first tie layer between the seal layer and the oxygen barrier layer, a second tie layer between the oxygen barrier layer and the abuse layer, and the alpha section is between the seal layer and the first tie layer.

In an embodiment, the beta section is between the alpha section and the first tie layer, and the beta section is directly laminated to the alpha section.

In an embodiment, the beta section is between the second tie layer and the abuse layer.

In an embodiment, the second film further comprises a outer seal layer, an outer abuse layer, an oxygen barrier layer between the outer seal layer and the outer abuse layer, a first tie layer between the seal layer and the oxygen barrier layer, and a second tie layer between the oxygen barrier layer and the abuse layer, and the gamma section is between the seal layer and the first tie layer.

In an embodiment, the delta section is between the gamma section and the first tie layer, and the delta section is directly laminated to the gamma section.

In an embodiment, the first film has a total thickness of from 0.2 to 1.2 mils.

In an embodiment, the second film has a thickness of from 0.2 to 1.2 mils.

In an embodiment, the first film has a total thickness of from 0.3 to 1 mil, and the second film has a thickness of from 0.3 to 1 mil.

In an embodiment, the first film and the second film each have: (i) a polyamide content of from 3 to 12 wt % on a total film weight basis, (ii) a total thickness of from 0.2 mil to 0.7 mil, and (iii) a recycle content of from 0 to 20 wt %, based on total film weight.

In an embodiment, the first film and the second film each have a polyamide content of from 4 to 11 wt % (tfb), the first film and the second film each have a total thickness of from 0.3 to 0.6 mil, and the first film and the second film each have a recycle content of from 0 to 15 wt % (tfb).

In an embodiment, the first film and the second film each have a polyamide content of from 5 wt % to 10 wt % (tfb), the first film and the second film each have a total thickness of from 0.35 to 0.45 mil, and the first film and the second film each have a recycle content of from 0 to 12 wt % (tfb).

In an embodiment, the first film has a total thickness of from 0.3 mil to 0.5 mil.

In an embodiment, the first film has a total thickness of from 0.35 mil to 0.45 mil.

In an embodiment, the first film contains polyamide in an amount of from 2 wt % to 20 wt % (tfb), with the alpha section and beta section together making up from 30 wt % to 80 wt % of the first film (tfb), with the first film having a total thickness of from 0.2 to 1.2 mils, with the first film containing from 0 wt % to 6 wt % recycle (tfb), with the second film containing polyamide in an amount of from 2 wt % to 20 wt % (tfb), with the gamma section and the delta section together making up from 30 wt % to 80 wt % of the second film (tfb), with the second film having a total thickness of from 0.2 to 1.2 mils, with the second film containing from 0 wt % to 6% recycle (tfb).

In an embodiment: (i) the first film contains polyamide in an amount of from 4 wt % to 12 wt % (tfb), with the alpha section and beta section together making up from 40 wt % to 70 wt % of the first film (tfb), with the first film having a total thickness of from 0.3 to 0.9 mil, with the first film containing from 0 wt % to 5 wt % recycle (tfb), and (ii) the second film contains polyamide in an amount of from 4 wt % to 12 wt % (tfb), with the gamma section and delta section together making up from 40 wt % to 70 wt % of the second film (tfb), with the second film having a total thickness of from 0.3 to 0.9 mil, with the second film containing from 0 wt % to 5 wt % recycle (tfb).

In an embodiment: (i) the first film contains polyamide in an amount of from 5 wt % to 10 wt % (tfb), with the alpha section and beta sections together making up from 45 wt % to 65 wt % of the first film (tfb), with the first film having a total thickness of from 0.4 mil to 0.8 mil, with the first film containing from 0 wt % to 3 wt % recycle (tfb), and (ii) the second film contains polyamide in an amount of from 5 wt % to 10 wt % (tfb), with the gamma section and delta sections together making up from 45 wt % to 65 wt % of the second film on a total film weight basis, with the first film having a total thickness of from 0.4 to 0.8 mil, with the first film containing from 0 wt % to 3 wt % recycle (tfb).

In an embodiment, the first and second outer layers of the first film have the same layer thickness and have the same polymeric composition, and the first and second tie layers of the first film have the same layer thickness and the same polymeric composition.

In an embodiment, the first film and the second film have the same number of layers, the same order of layers, the same layer composition, and the same layer thickness.

In an embodiment, the chambers extend transversely across the inflatable article, the chambers extending from a closed inflation manifold which extends along a machine direction.

In an embodiment, the chambers extend transversely across the inflatable article, the chambers extending from an open skirt which extends along a machine direction.

In an embodiment, each chamber comprises from 3 to 40 cells.

In an embodiment, the cells have a major uninflated axis which has a length of from 0.5 inch to 2.5 inches.

In an embodiment, the first film has a total free shrink, measured in accordance with ASTM D2732, of less than 10% at 85° C.

In an embodiment, both the first film and the second film have a total free shrink, measured in accordance with ASTM D2732, of less than 10% at 85° C.

In an embodiment, none of the microlayers in the first film comprises polyurethane. In an embodiment, none of the microlayers in the second film comprises polyurethane. In an embodiment, neither the microlayers in the first film nor the microlayers in the second film comprise microlayers. Claim 38: The inflatable cushioning article according to any of claims 1-37, wherein the first and second films do not comprise a crosslinked polymer network.

In an embodiment, the first film is sealed to itself.

### BRIEF DESCRIPTION OF THE DRAWINGS

FIG. 1 is a schematic of an uninflated, inflatable article in lay-flat configuration.

FIG. 2 is a schematic of the article of FIG. 1 after inflation.

FIG. 3A is an enlarged cross-sectional schematic view of a multilayer film for use in the inflatable article of the presently disclosed subject matter.

FIG. 3B is an enlarged cross-sectional schematic view of a comparative multilayer film for use in a comparative inflatable article.

FIG. 4A is a flow diagram of a process for making the inflatable article.

FIG. 4B is a schematic of a process for making the inflatable article.

FIG. 5 is a lay-flat view of a section of inflatable article which has been modified for conducting a burst test.

FIG. 6A is a longitudinal sectional view of an inflation nozzle to be used in the burst test.

FIG. 6B is a cross-sectional view of the inflation nozzle of FIG. 6A, taken through line 6B-6B of FIG. 6A.

FIG. 6C is a cross-sectional view of the inflation nozzle of FIG. 6A, taken through line 6C-6C of FIG. 6A.

FIG. 7A is a longitudinal view of a pair of clamping cauls used to clamp the inflatable article to the inflation nozzle of FIGS. 6A, 6B, and 6C.

FIG. 7B is a cross-sectional view of the clamping cauls of FIG. 7A, taken through line 7B-7B of FIG. 7A.

FIG. 8A is a detail view of an assembly which includes that portion of the modified inflatable article which contains the inflation nozzle and the clamping cauls.

FIG. 8B is a schematic cross-sectional view of the assembly of FIG. 8A.

### DETAILED DESCRIPTION

As used herein, the term “layer” is used generically to refer to both a bulk layer as well as an individual microlayer.

As used herein, the phrases “inner layer” and “internal layer” and “core layer” refer to any layer, of a multilayer film, having both of its principal surfaces directly adhered to another layer of the film.

As used herein, the phrase “outer layer” refers to any film layer of film having less than two of its principal surfaces directly adhered to another layer of the film. The phrase is inclusive of monolayer and multilayer films. In multilayer films, there are two outer layers, each of which has a principal surface adhered to only one other layer of the multilayer film. In monolayer films, there is only one layer, which, of course, is an outer layer in that neither of its two principal surfaces is adhered to another layer of the film.

As used herein, the phrase “inside layer” refers to the outer layer of a multilayer film which is closest to the gas in the chambers after inflation, relative to the other layers of the multilayer film. The “inside surface” of the film is the surface in contact with the gas in the chambers after inflation.

As used herein, the phrase “outside layer” refers to the outer layer of a multilayer film which is furthest to the gas in the chambers after inflation, relative to the other layers of the multilayer film. The “outside surface” of the film is the surface of the film which is the furthest from the gas in the chambers after inflation.

As used herein, the phrase “bulk layer” refers to a single film layer which is not a microlayer and which is present to impart strength and/or to provide the film with adequate thickness for its intended use. A bulk layer can be a single layer which is present in place of one or more sections of microlayers. As used herein, the phrase “core layer” refers to a bulk layer which is an internal film layer.

As used herein, the term “microlayer” refers to any layer formed upon passing through a layer multiplier (e.g., use of a static mixer under laminar flow conditions). Generally the film comprises at least 4 microlayers. Each microlayer may have, for example, a thickness of from 0.001 to 0.1 mil in the finished film.

With respect to microlayers, the term “section” as used herein refers to a group of microlayers formed by passage through the same set of flow splitters (i.e., layer multipliers) and thereafter through the same distribution plate of the extrusion die. A section has a minimum of 4 microlayers. A section contains no layers that are not microlayers.

Microlayers can have a thickness of from 0.001 mil to 0.1 mil. Even though a conventional film layer can have a thickness of less than 0.1 mil, herein it is not considered to be a microlayer unless it is present in combination and directly adhered to at least one additional layer having a thickness of less than 0.1 mil.

Generally, the thickness M of a microlayer section may be greater, the same, or less than the thickness D of a bulk layer emerging from the distribution plates of the die through which the layers are extruded. The thinner the individual microlayers of the microlayer section are relative to the thickness of the bulk layers from the distribution plates, the more microlayers that can be included in the multilayer film, for a given overall film thickness.

The thickness of individual microlayers may be the same or different among the microlayers flowing from the microlayer distribution plate of the die, in order to achieve a desired distribution of layer thicknesses in the microlayer section of the resultant film. Similarly, thickness D may be the same or different among the thicker bulk layers flowing from the bulk layer distribution plates to achieve a desired distribution of layer thicknesses in the bulk-layer section(s) of the resultant film.

The layer thicknesses M and D will typically change as the fluid flows downstream through the die, e.g., upon further downstream processing of the tubular film, e.g., by stretching, orienting, or otherwise expanding the web to achieve a final desired film thickness and/or to impart desired properties into the film. The flow rate of fluids through the plates will also have an effect on the final downstream thicknesses of the corresponding film layers.

As used herein, the term “adhered” is inclusive of films which are directly adhered to one another using a heat lamination or other means, as well as films which are adhered to one another using an adhesive which is between the two films.

As used herein, the term “seal” is generic in that it includes adhesion of a portion of a film surface to itself or a portion of the surface of another film, using an adhesive, heat, or corona bonding. In contrast to being heat sealed to one another, the various layers of a multilayer coextruded film, and the various layers of an extrusion coated film, are considered to be “laminated” to one another, as the entirety of a surface of one film layer adheres directly to the entirety of the surface of the layer to which it is laminated. The phrases “direct lamination” and directly laminated to” refer to layers that are laminated to one another without any layers therebetween. Laminated layers are not to be considered to be “sealed” or “heat sealed” to one another. Rather, the term “seal”, and the phrase “heat seal,” refer to adhering less than an entire surface of a first film to itself or to less than an entire surface of a second film or other second component of a package.

As used herein, the phrase “heat seal” refers to any seal of a first portion of a film surface to a second portion of a film surface, wherein the seal is formed by heating one or both of the regions to at least their respective seal initiation temperatures. Heat sealing can be performed by any one or more of a wide variety of manners. Heat sealing can be carried out by contacting the films with a heated drum to produce a heat seal, as described below.

As used herein, the phrase “homogeneous polymer” refers to polymerization reaction products of relatively narrow molecular weight distribution and relatively narrow composition distribution. Homogeneous polymers are useful in various layers of the multilayer film for making the inflatable article. Homogeneous polymers are structurally different from heterogeneous polymers, in that homogeneous polymers exhibit a relatively even sequencing of comonomers within a chain, a mirroring of sequence distribution in all chains, and a similarity of length of all chains, i.e., a narrower molecular weight distribution. Furthermore, homogeneous polymers are typically prepared using metallocene, or other single-site type catalysis, rather than using Ziegler Natta catalysts.

A homogeneous ethylene/alpha-olefin copolymer can, in general, be prepared by the copolymerization of ethylene and any one or more alpha-olefin. The alpha-olefin may be any of a C₃-C₂₀ alpha-monoolefin, a C₄-C₁₂ alpha-monoolefin, and a C₄-C₈ alpha-monoolefin. The alpha-olefin may comprise at least one member selected from the group selected from butene-1, hexene-1, and octene-1, i.e., 1-butene, 1-hexene, and 1-octene, respectively. The alpha-olefin may comprise octene-1, and/or a blend of hexene-1 and butene-1.

Processes for preparing and using linear homogeneous polymers are disclosed in U.S. Pat. Nos. 5,206,075, 5,241,031, and PCT International Application WO 93/03093, each of which is hereby incorporated by reference thereto, in its entirety. Still another genus of homogeneous ethylene/alpha-olefin copolymers are the “substantially linear” homogeneous copolymers, also referred to as “long chain branched” homogeneous copolymers, disclosed in U.S. Pat. No. 5,272,236, to LAI, et. al., and U.S. Pat. No. 5,278,272, to LAI, et. al., both of which are hereby incorporated by reference thereto, in their respective entireties. Each of these patents discloses substantially linear homogeneous long chain branched ethylene/alpha-olefin copolymers produced and marketed by The Dow Chemical Company.

Useful films for making the inflatable cellular cushioning article include, among others, multilayer films having a seal layer, a gas barrier layer (typically an O₂-barrier layer), and a tie layer between the seal layer and the gas barrier layer. Useful multilayer structures further include multilayer films having the structure: seal layer/first tie layer/barrier layer/second tie layer/abuse layer. Still further useful multilayer structures include films having the structure: seal layer/core layer/first tie layer/barrier layer/second tie layer/abuse layer.

Although a microlayer section may be substituted for any one or more of the layers identified in the paragraph above, a microlayer section can be substituted for one or more of the seal layer, the abuse layer, the barrier layer, and the core layer(s). In some embodiments, one or more microlayer sections are provided. Two or more microlayer sections may coextruded adjacent one another, i.e., directly adhered to one another, also referred to herein as being laminated to each other.

One or more microlayer sections may be substituted for one or more core layers in a film to be used for making the inflatable cushioning article. The microlayer section comprises a plurality of microlayers laminated to one another. The microlayer section may have, for example, from 10-100 microlayers. Microlayer sequences may comprise alternating series f resins. Examples of alternating sequences of resin pairs include LL/VL, EVA/LD, VL/m-LL, EVA/EPB, and UL/LL, wherein LL=linear low density polyethylene, VL=very low density polyethylene, LD=low density polyethylene, UL=ultra low density polyethylene, m-LL=anhydride modified linear low density polyethylene, EVA=ethylene/vinyl acetate copolymer, and EPB=ethylene/propylene/butene copolymer. Resin combinations can be simply alternated with each microlayer being only one resin, or blended and alternated with some or all of the microlayers comprising resin blends. Examples of microlayer layer arrangements include: (A+B)ₙ, (AB)ₙ, (A/B)ₙ/A, [A/(A+B)]ₙ, and [A/(A+B)]ₙ, where n is an integer, “+” refers to blended components, “A” refers to a first resin, and “B” refers to a second resin different from the first resin. The ratio between resin A and resin B in the core layer can be, for example, from 9:1 to 1:9 or from 3:7 to 7:3.

Seal layers may comprise any heat sealable polymer, including ionomer resin, polyolefin (e.g., high density polyethylene, low density polyethylene, and ethylene/α-olefin copolymers such as medium density polyethylene, linear low density polyethylene, very low density polyethylene, and ultra low density polyethylene), ethylene/propylene copolymer, and polystyrene; for high temperature applications the seal layer may even comprise, or consist of, polyamide, polyester, polyvinyl chloride. Seal layers may contain a polymer having a major DSC peak of up to, for example, of less than 130° C., or less than 125° C., or less than 120° C., or less than 115° C., or less than 110° C., or less than 105° C., or an ethylene/vinyl acetate copolymer having a melt point below 80° C. Polymers for use in the seal layers include ionomer resin and olefin homopolymers and copolymers, the latter including homogeneous and heterogeneous ethylene/α-olefin copolymers.

Homogeneous ethylene/alpha-olefin copolymers include homogeneous linear ethylene/α-olefin copolymer, and homogeneous ethylene/alpha-olefin copolymer having long chain branching. Homogeneous ethylene/α-olefin copolymer having long chain branching includes AFFINITY® substantially linear homogeneous ethylene/alpha-olefin copolymer manufactured by The Dow Chemical Company. Homogeneous linear ethylene/α-olefin copolymer includes EXACT® linear homogeneous product manufactured by the Exxon Chemical Company. Ethylene/α-olefin copolymer may be ethylene/hexene copolymer, ethylene/octene copolymer, or ethylene/butene copolymer.

Although the inflatable article is made by sealing two outer film layers to one another, if the film cross-section is symmetrical with respect to outer layer composition, one outer layer serves as a seal layer and the other outer layer serves as an abuse layer, even though only one of the layers is heat sealed to the other film making up the inflatable article, or sealed to itself if the inflatable article is made by folding a single film and sealing it to itself. In some instances the seal layers are present for more purposes than just sealing. The seal layers can provide much of the strength, bulk, abuse, abrasion, and impact strength properties for the inflatable article. In some embodiments, the cross section of the multilayer film is symmetrical with respect to layer arrangement, layer thickness, and layer composition.

The gas barrier layer provides the multilayer film with the property of being relatively impervious to one or more atmospheric gases, such as nitrogen and/or oxygen and/or argon and/or carbon dioxide. This provides the inflated cushioning product with a longer life, as the gas barrier layer allows the inflated cushioning article to retain gas in the cells for a longer period of time. A gas barrier layer helps to reduce loss of fluid under load. Without a gas barrier layer, the cushioning product under load can exhibit substantial loss of fluid (i.e., “creep”) within four to seven days. The barrier layer can comprise polymer which crystallizes upon aging and the inflatable cellular cushioning product for a temperature and time to ensure that the crystallization of the polymer in the gas barrier layer is substantially complete.

Suitable resins for use in the gas barrier layer include crystalline polyamide, crystalline polyester, ethylene/vinyl alcohol copolymer (i.e., saponified ethylene/vinyl acetate copolymer), polyacrylonitrile, polyvinylidene chloride, and crystalline polycycloolefin. The crystalline polymer in the gas barrier layer may include one or more crystalline polyamide, such as polyamide 6, polyamide 66, polyamide 9, polyamide 10, polyamide 11, polyamide 12, polyamide 69, polyamide 610, polyamide 612, and copolymers thereof. Crystalline polyesters include polyethylene terephthalate and polyethylene naphthalene, and polyalkylene carbonate. Saponified ethylene/vinyl acetate copolymer (frequently referred to as EVOH) is a crystalline copolymer suitable for use in the gas barrier layer. Crystalline cycloolefin polymers can make suitable gas barrier layers. Ticona is a manufacturer of such polycycloolefins. A gas barrier layer can be made from 100% CAPLON® B100WP polyamide 6 having a viscosity of FAV=100 (i.e., FAV=formic acid viscosity), obtained from Allied Chemical.

As used herein, the phrase “tie layer” refers to any internal layer having the primary purpose of adhering two layers to one another. A tie layer contains a polymer capable of covalent bonding to polar polymers such as polyamide and ethylene/vinyl alcohol copolymer. The tie layer may serve to adhere the seal layer to the gas barrier layer. The tie layer can comprise any polymer having a polar group thereon (particularly a carbonyl group), or any other polymer which provides sufficient interlayer adhesion to adjacent layers which comprise polymers which do not adequately adhere to one another.

As used herein, the phrase “modified polymer”, as well as more specific phrases such as “modified ethylene vinyl acetate copolymer”, and “modified polyolefin” refer to such polymers having an anhydride functionality, as defined below, grafted thereon and/or copolymerized therewith. Such modified polymers may have the anhydride functionality grafted on or polymerized therewith, as opposed to merely blended therewith.

As used herein, the phrase “anhydride functionality” refers to any form of anhydride functionality, such as the anhydride of maleic acid, fumaric acid, etc., whether blended with one or more polymers, grafted onto a polymer, or copolymerized with a polymer, and, in general, is also inclusive of derivatives of such functionalities, such as acids, esters, and metal salts derived therefrom.

Tie layer polymers include olefin/unsaturated ester copolymer, olefin/unsaturated acid copolymer, and anhydride-modified olefin polymers and copolymers, e.g., in which the anhydride is grafted onto the olefin polymer or copolymer. More particularly, polymers for use in tie layers include anhydride-modified polyolefin, anhydride-modified ethylene/α-alpha-olefin copolymer, ethylene/vinyl acetate copolymer, ethylene/butylacrylate copolymer, ethylene/methyl methacrylate copolymer, ethylene/acrylic acid copolymer, ethylene/methacrylic acid copolymer, and polyurethane. The anhydride-modified ethylene/α-olefin copolymer can be anhydride-modified ethylene/C₄₋₁₀ alpha-olefin copolymer, or anhydride-modified ethylene/C₄-8 copolymer. Modified polymers suitable for use as tie layers are described in U.S. Pat. No. 3,873,643, to Wu et al, entitled “Graft Copolymers of Polyolefins and Cyclic acid and acid anhydride monomers”; U.S. Pat. No. 4,087,587, to Shida, et al, entitled “Adhesive Blends”; and U.S. Pat. No. 4,394,485, to Adur, entitled “Four Component Adhesive Blends and Composite Structures”, each of which is hereby incorporated, in their entirety, by reference thereto.

Polymers for use in the tie layer may include olefin polymers which are modified (e.g., grafted) with one or more monomers such as acrylic acid, methacrylic acid, fumaric acid, maleic acid, maleic anhydride, 4-methyl cyclohex-4-ene-1,2-dicarboxylic acid anhydride, bicyclo(2.2.2)oct-5-ene-2,3-dicarboxylic acid anhydride, 1,2,3,4,5,8,9,10-octahydronaphthalene-2,3-dicarboxylic acid anhydride, 2-oxa-1,3-diketospiro(4.4)non-7-ene, bicyclo(2.2.1)hept-5-ene-2,3-dicarboxylic acid anhydride, maleopimaric acid, tetrahydrophthalic anhydride, x-methylbicyclo(2.2.1)hept-5-ene-2,3-dicarboxylic acid anhydride, x-methylnorbom-5-ene-2,3-dicarboxylic acid anhydride, norbom-5-ene-2,3-dicarboxylic acid anhydride, Nadic anhydride, methyl Nadic anhydride, Himic anhydride, methyl Himic anhydride and other fused ring monomers, as known to those of skill in the art.

In embodiments of the inflatable cellular cushioning article of the presently disclosed subject matter, the tie layer provides a desired level of adhesive and cohesive strength in order to prevent the multilayer film from delaminating when the article is inflated to an internal pressure of 3 psi under standard conditions (i.e., 25° C. and 1 atmosphere pressure), and thereafter subjected to harsh conditions, for example, 140° F. for 4 hours. It has been found that various tie layer polymers are capable of providing a level of adhesive and cohesive strength adequate to provide the 3 psi inflated article with the desired performance properties when subjected to harsh conditions.

A tie layer made of 100 percent anhydride grafted low density polyethylene having an anhydride content of at least 160 parts per million based on resin weight (as measured by pyrolysis GC-MS) has been found to provide adequate adhesive and cohesive strength to prevent delamination when the inflatable article is inflated to 3 psi. A tie layer made of 100 percent anhydride grafted linear low density polyethylene having an anhydride content of 190 parts per million based on resin weight, provided adequate adhesive and cohesive strength to prevent delamination under harsh conditions, such as use in an inflated cellular cushioning article having an internal pressure of 3 psi, with the inflated article being subjected to 140° F. for 4 hours, or a reduced external pressure of 0.542 atmospheres for 5 minutes. The modified polyolefin can be selected from modified LLDPE, modified LDPE, modified VLDPE, and modified homogeneous ethylene/alpha-olefin copolymer. The polyolefin can be anhydride modified, e.g., the polyolefin may have an anhydride content of at least 150 ppm based on resin weight, or at least 155 ppm, or at least 160 ppm, or at least 165 ppm, or at least 170 ppm, or at least 175 ppm, or at least 180 ppm, or at least 185 ppm, or at least 190 ppm, based on resin weight. The modified polyolefin may have an anhydride content of from 150 to 1000 ppm based on resin weight, or from 160 to 500 ppm, or from 165 to 300 ppm, or from 170 to 250 ppm, or from 175 to 220 ppm, or from 180 to 210 ppm, or from 185 to 200 ppm, based on resin weight.

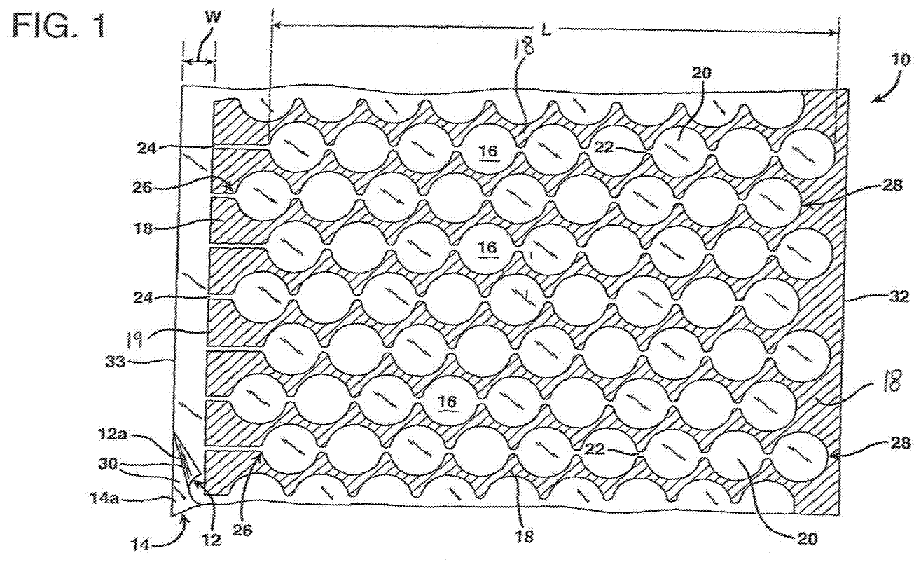

Referring to FIG. 1, there is shown uninflated inflatable article 10 comprising two films 12 and 14 having respective inner surfaces 12a and 14a sealed to each other in a pattern defining a series of inflatable chambers 16 of predetermined length “L.” Length L may be substantially the same for each of the chambers 16, with adjacent chambers being off-set from one another as shown in order to arrange the chambers in close proximity to one another. Films 12 and 14 are sealed to each other in a pattern of seals 18, leaving unsealed areas which define inflatable chambers 16 such that each chamber 16 has at least one change in width over its length L. That is, seals 18 may be patterned to provide in each chamber 16 a series of sections 20 of relatively large width in fluid communication with the other cells of the chamber via relatively narrow connecting channels 22. When inflated, sections 20 may provide approximately spherical bubbles in inflatable article 10 by symmetrical outward movement of those sections of films 12 and 14 comprising the walls of sections 20. This will generally occur when films 12 and 14 are identical in thickness, flexibility, and elasticity. Films 12 and 14 may, however, be of different thickness, flexibility or elasticity such that inflation will result in different displacement of films 12 and 14, thereby providing somewhat hemispherical or otherwise asymmetrical bubbles.

Seals 18 are also patterned to provide inflation ports 24, which are located at proximal end 26 of each of inflatable chambers 16 in order to provide access to each chamber so that the chambers may be inflated. Opposite proximal end 26 of each chamber 16 is closed distal end 28. As shown, seals 18 at proximal end 26 are intermittent, with inflation ports 24 being formed therebetween. Although optional, inflation ports 24 are illustrated narrower in width than inflatable sections 20 of relatively large width, in order to minimize the size of the seal required to close off each chamber 16 after inflation thereof.

Inflatable article 10 further includes a pair of longitudinal flanges 30 (also herein referred to as an open skirt), which are formed by a portion of each of films 12 and 14 that extend beyond inflation ports 24 and intermittent seals 18. In the embodiment shown in FIG. 1, flanges 30 extend out equally beyond inflation ports 24 and seals 18. Flanges 30 accordingly are of equal widths with one another, illustrated as width “W.” Flanges 30, in conjunction with ports 24 and seals 18, constitute an open inflation zone in inflatable article 10 that is advantageously configured to provide rapid and reliable inflation of chambers 16. The inner surfaces of flanges 30 can be brought into close slidable contact with outwardly facing surfaces of an appropriately configured nozzle or other inflation means so as to provide a partially closed inflation zone which promotes efficient and reliable sequential inflation of chambers 16 without restricting the movement of the web or inflation nozzle that is required to effect this sequential inflation. Flanges 30 can be at least ¼ inch in width, or at least ½ inch in width. Flanges 30 may have different widths, but flanges 30 may also be of equal width, as shown in FIG. 1. An exemplary apparatus and method for effecting inflation and sealing of the chambers is disclosed in U.S. Pat. No. 7,220,476, to Sperry et. al., entitled “Apparatus and Method for Forming Inflated Chambers,” which is incorporated herein in its entirety by reference.

The seal pattern of seals 18 may provide uninflatable planar regions between chambers 16. These planar regions serve as flexible junctions that may advantageously be used to bend or conform the inflated article about a product in order to provide optimal cushioning protection. In another embodiment, the seal pattern can comprise relatively narrow seals that do not provide planar regions. These seals serve as the common boundary between adjacent chambers. Such a seal pattern is shown for example in U.S. Pat. No. 4,551,379, to Kerr, entitled “Inflatable Packaging Material,” the disclosure of which is incorporated, in its entirety, by reference thereto. In the inflatable article 10 illustrated in FIG. 1, seals 18 may be heat seals between the inner surfaces of the films 12 and 14. Alternatively, films 12 and 14 may be adhesively bonded to each other. Heating films 12 and 14 in the area of seals 18 can provide a very strong bond. Although the phrase “heat seal” is generally used herein, this phrase should be understood to include the formation of seals 18 by adhesion of films 12 and 14 with adhesive as well as by heat sealing. Multilayer films 12 and 14 comprise a thermoplastic heat sealable polymer on their inner surface such that, after superposition of films 12 and 14, inflatable article 10 can be formed by passing the superposed sheets over a sealing roller having heated raised land areas that correspond in shape to the desired pattern of seals 18, as described hereinbelow. The sealing roller applies heat and forms seals 18 between films 12 and 14 in the desired pattern, and thereby also forms inflatable chambers 16 with a desired shape. The sealing pattern on the sealing roller also provides intermittent seals at proximal end 26, thus forming inflation ports 24 and also effectively resulting in the formation of flanges 30. Further details concerning methods making inflatable article 10 are disclosed below and are also set forth in commonly-assigned U.S. Pat. No. 6,800,162, entitled INTEGRATED PROCESS FOR MAKING INFLATABLE ARTICLE (Kannankeril et al.), filed on Aug. 22, 2001, the entire disclosure of which is hereby incorporated herein by reference, as well as U.S. Pat. No. 6,982,113, entitled HIGH STRENGTH HIGH GAS BARRIER CELLULAR CUSHIONING PRODUCT, to Kannankeril et al., filed on 22 Nov. 2002, the entire disclosure of which is also hereby incorporated herein by reference.

The heat sealability of films 12 and 14 is enabled by providing films 12 and 14 as multilayer films, each contacting the other with an outer film layer comprising a heat sealable polymer composition. This not only provides for the formation of heat seals 18, it also provides a manner by which inflation ports 24 can be closed by heat sealing means after inflation of a corresponding chamber.

Films 12 and 14 are initially separate films that are brought into superposition and sealed, or they may be formed by folding a single sheet onto itself with the heat sealable surface facing inward. The longitudinal edge opposite from flanges 30, shown as edge 32 in FIG. 1, may be a closed edge of a single piece of folded film, or may be the respective edges of two discrete pieces of film 12 and 14 that have been sealed together. Although not illustrated in FIG. 1, edge 32 may be in an unsealed area providing an additional pair of flanges similar to flanges 30, in order to provide a second open inflation zone for inflating a second series of inflatable chambers or for inflation of the chambers from both ends. Optionally, the unsealed portion could further include a passageway in the machine direction which serves as a manifold, i.e. connecting each of the passageways along an edge of the article. This can permit faster inflation of the article.

The resulting inflatable article was made by sealing in the pattern illustrated in FIG. 1. FIG. 2 illustrates inflated article 11 after inflation is complete and after seal 25 has been made across the intermittent portions of seal 18 at the ends proximate inflation ports 24, thereby closing inflation ports 24 by connecting the discontinuous portions of seals 18 at the ends proximate inflation ports 24.

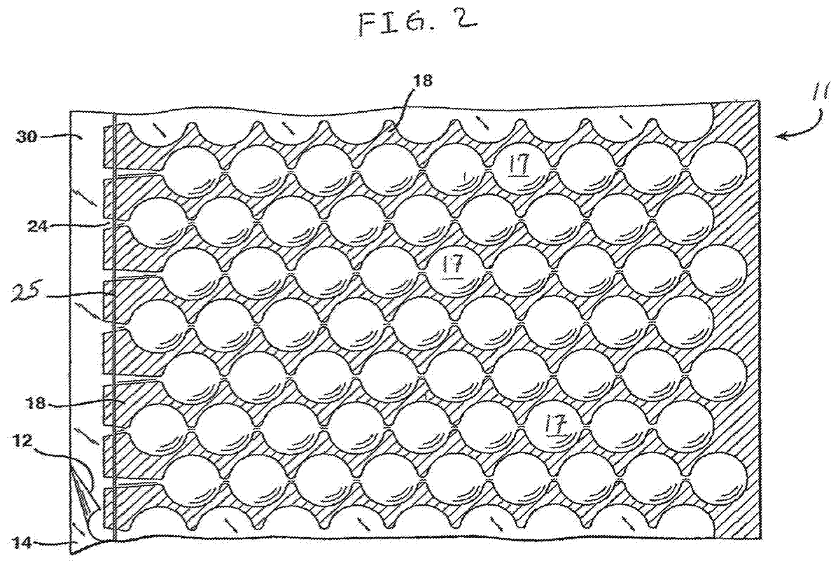

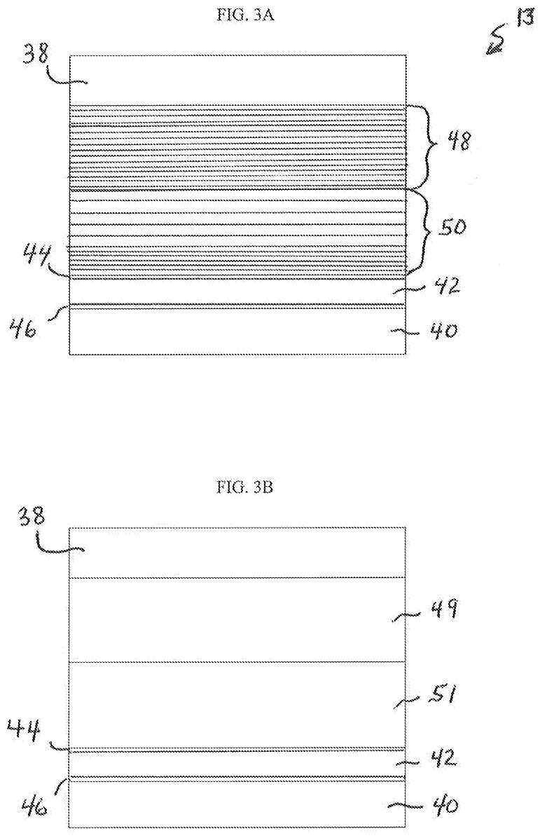

FIG. 3A is an enlarged cross-sectional schematic view of multilayer film 13 which can serve as film 12 and/or film 14 in the inflatable article 10 illustrated in FIG. 1 and the inflated article 11 illustrated in FIG. 2. Multilayer film 13 in FIG. 3A has outer heat seal layer 38, outer abuse layer 40, oxygen barrier layer 42, first tie layer 44, second tie layer 46, and two additional sections 48 and 50. In the working examples herein, section 48 contains 16 microlayers formed by splitting a plurality of molten streams of polymers into multiple layers streams via a plurality of static in-line mixers. That is, two identical or different polymeric streams may for example be split into four streams, which are then split into 8 streams, which are then split into 16 streams, thereby producing a total of 16 microlayers which are present in, for example, “alpha section” 48 of multilayer film 13. The same can be done for “beta section” 50 of multilayer film 13. Each section may have, any desired number of microlayers such as 4, 8, 16, 32, 64, 128, etc. In the examples below, alpha section 48 contained 16 microlayers, and beta section 50 contained 16 layers, for a total of 32 microlayers in various multilayer films used to make inflatable article 10.

In contrast, FIG. 3B illustrates an enlarged cross-sectional schematic view of multilayer film 15 which is used in the comparative examples herein. As in multilayer film 13, multilayer film 15 in FIG. 3B has outer heat seal layer 38, outer abuse layer 40, oxygen barrier layer 42, first tie layer 44, second tie layer 46, and two core layers 49 and 51. In the comparative examples, heat seal layer 38, outer abuse layer 40, oxygen barrier layer 42, first tie layer 44, and second tie layer 46 are identical in location, composition, and thickness of the corresponding layers of in working multilayer film 13. However, whereas multilayer film 13 contained internal microlayer sections 48 and 50, multilayer film 15 had internal core layer 49 which was a single layer (with no microlayers) and internal core layer 51 was also a single layer (with no microlayers).

The inflatable article can be made from two films sealed together or from a single folded film or film tubing in lay-flat configuration. The two discrete films, the two leaves of the folded film, or the two sides of the film tubing in lay-flat configuration can be sealed to each other in selected seal regions, forming a pattern of sealed and unsealed portions, the latter of which define chambers, inflation channels, connecting passageways, an inflation skirt or a closed inflation manifold. The resulting inflatable article is inflatable (i.e., upon inflation and sealing to entrap the inflation gas or fluid therewithin), and provides a plurality of closed, fluid-filled chambers, with the inflated article being useful as a cushioning device as well as a for package void-fill and dunnage. The inflatable article can be fabricated from laminated materials produced from polymeric resins in a one stage process that eliminates disadvantages associated with multiple stage processes.

A first embodiment of a process for making the inflatable laminated article comprises: (A) extruding a first film and a second film, at least one of which comprises a plurality of microlayers; (B) cooling the first film and the second film so that the films will not fuse to one another upon contact with each other; (C) contacting the first film with the second film; (D) heating selected portions of at least one of the first and second films to a temperature above a fusion temperature, so that the first and second films are heat sealed to one another at a selected area, with the selected area providing a heat seal pattern in which the unsealed portions between the films provide inflatable chambers between the first film and the second film. Of course, if one or more of the films are multilayer films having a sealing layer, the heating of such film need only be to a temperature above the fusion temperature of at least the seal layer of one or more of the films.

The step (C) of contacting the first film with the second film, followed by (D) heating selected portions of the first and second film, may be carried out with step C preceding step D, or the order in which the process is carried out may be reversed, i.e., by first heating selected portions of at least one of the films followed by contacting the first film with the second film so that the first and second films are heat sealed to one another at selected areas. Moreover, the selected areas need not correspond exactly with the selected portions which are heated. That is, the portions which are heat sealed may be slightly larger or slightly smaller than the selected portions which are heated.

While the cooling can be active (e.g., contacting one or more films with one or more chilled rolls, belts, the use of cool air or water, etc.), it can also be passive, e.g., simply providing the first and second films enough time to cool under ambient conditions so that they do not fuse to one another upon contact. Thereafter, in order to heat seal the films to one another, it is necessary to heat at least the seal layers of one or both of the films to a temperature at or above a temperature at which the one or more of the seal layers will fuse.

The first and second films may be extruded simultaneously. In one embodiment, both films are extruded from the same extruder, as is required when making the article from a folded film or from an annular film. In another embodiment, two discrete films are extruded from separate dies, either annular or slot dies. The two films can be extruded using the same extruder or using separate extruders. If an annular die is used, the resulting lay-flat tubing can either be self-welded into a flat film, or converted to a flat film by being slit in the machine direction.

If the article is produced using an annular film in lay-flat configuration or using a folded flat film, obviously both film leaves are forwarded together at the same speed. If the article is produced using separate flat dies, or separate annular dies with the annular films being slit to be opened, contacting of the first film with the second film is carried out by forwarding the first film and second film together at the same speed. Although heating of selected portions of one or more of the films or film leaves can be carried out before the films contact one another, the heating of the selected portions of the first and second films (or the film leaves) may be is carried out while the first and second films are in contact with one another, with the heat sealing being carried out using a combination of heat and pressure. In an embodiment, the contacting step and the heating step are performed simultaneously, with pressure being simultaneous with the heating, resulting in contacting and heat sealing being essentially simultaneous. During sealing, heat and pressure may be applied simultaneously.

Heating may be performed by passing the first and second films (or film leaves) together in a partial wrap around a heated roller having a surface which is raised in a pattern corresponding with a desired seal pattern. The films (or film leaves) may also (or optionally) be passed through the nip between the heated roller having the raised surface and a second roller in nip relationship thereto, with the raised surface roller having the raised surface in the pattern of the desired seal. The raised surface roller may be heated. However, both rollers may be provided with the raised surface, with the raised surfaces being operatively aligned to heat seal the selected portions of the first and second films (or first and second film leaves) to produce the inflatable article. The one or more raised surface rollers may each have a raised surface which is continuous around the roller, so that the nip between the first and second rollers is maintained throughout rotation of the first and second rollers, without further means to maintain the nip. If one of the rollers in nip relation does not have a raised surface, such roller may have a smooth, continuous surface to ensure that the nip is maintained throughout rotation of the roller. Alternatively, means can be provided to maintain the nip between irregular rollers, such as a resilient surface on one or more of the rolls, gearing connecting the rollers, and/or a roll on a moveable axis with force continuously urging the rollers into contact with one another despite irregularities. The first and second films are heat sealed to one another in a repeating pattern of sealed and unsealed areas.

A second embodiment of a process for making the inflatable article comprises: (A) extruding a tubular film having an outside surface and an inside surface, the tubular film comprising a plurality of microlayers; (B) cooling the tubular film to a temperature low enough that the inside surface of the tubular film is cool enough not to adhere to itself; (C) placing the tubular film into the lay-flat configuration having a first lay-flat side and a second lay-flat side, so that a first inside lay-flat surface of the first lay-flat side of the tubular film is in contact with a second inside lay-flat surface of the second lay-flat side of the tubular film; and, (D) heating sealing selected portions of the first lay-flat side of the tubular film to the second lay-flat side of the tubular film, the heat sealing being carried out to provide a pattern of sealed and unsealed areas with the unsealed areas providing inflatable chambers between the first lay-flat side of the tubular film and the second lay-flat side of the tubular film. Depending upon the pattern of the heat sealing, the resulting heat sealed (i.e., laminated) article may or may not have to be slit along one or both side edges (i.e., slit in the machine direction) in order to provide access for means for inflating the inflatable chambers. This alternative process may otherwise be carried out in accordance with features set forth above in the first embodiment process for making the inflatable article.

A third embodiment of a process form making the inflatable article comprises: (A) extruding a flat film comprising a plurality of microlayers, the flat film having a first outer surface and a second outer surface; (B) cooling the film so that the first outer surface is cool enough not to adhere to itself upon being doubled back against itself; (C) folding the film to make a crease in a machine direction of the film, with a first leaf of the film being on a first side of the crease and a second leaf of the film being on a second side of the crease, the first leaf being flat against the second leaf so that the first outer surface is doubled back against itself; and (D) heating sealing selected portions of the first leaf to the second leaf, the heat sealing being carried out to provide a pattern of sealed and unsealed areas with the unsealed areas providing inflatable chambers between the first leaf and the second leaf. The third aspect of the presently disclosed subject matter may also carried out in accordance with features set forth above in the first aspect of the presently disclosed subject matter.

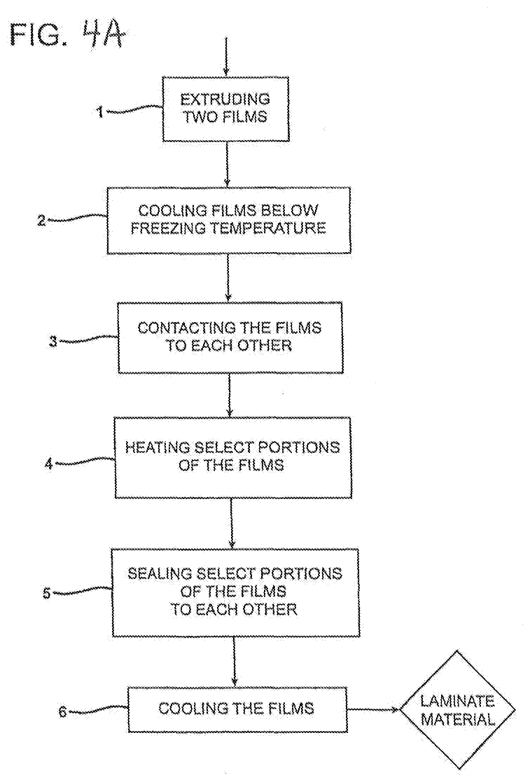

FIG. 4A is a flow chart illustrating various steps of a one-stage integrated process for making an inflatable laminated articles. Reference numerals 1 through 6 are employed to indicate the steps. The method of making the inflatable laminated article is carried out by extruding two films 1; cooling the films to a temperature below the fusing temperature of each of the films 2; contacting the first and second films to each other 3, heating selected portions of the films 4, sealing the select heated portions of the first film to the second film 5, and cooling the films to form the laminate material 6. Although cooling step 6 can be passive (e.g., in that the heat seals are simply allowed to cool by giving off heat to the ambient environment), it may be active in order to quickly cool the heat seals immediately after formation, so that the heat seal is not damaged or weakened by continued processing.

FIG. 4B is a schematic of an apparatus and process 50 for making an inflatable cushioning article by heat sealing two films together in a pattern that produces a plurality of chambers. In FIG. 4, extruders 52 and 54 extrude first multilayer film 56 and second multilayer film 58, respectively, from slot dies, as shown. After extrusion, film 56 makes a partial wrap around heat transfer (cooling) roller 60, which may have a diameter of 8 inches and which is maintained at a surface temperature well beneath the fusion temperature of the extrudate, e.g., from 100-150° F. Second film 58 makes a partial wrap around each of heat transfer (cooling) rollers 62 and 64, each of which has a diameter of 8 inches and each of which is maintained at a surface temperature similar to that of cooling roller 60. After cooling, first film 56 makes a partial wrap (about 90 degrees) around Teflon® coated rubber nip roll 66, which has a diameter of 8 inches and which has, as its primary function, maintaining nip with heat transfer (heating) raised surface roller 70. While first film 56 is passing over nip roller 66, second film 58 merges with first film 56, with both films together being wrapped for a short distance around nip roll 66 before together entering first nip 68. Nip roller 66 provides a location of films 56 and 58 to come together without being marred or distorted.

Thereafter, second film 58 makes direct contact with raised surface roll 70 (which is illustrated as a smooth roll only for simplicity of illustration). First nip 68 may subject films 56 and 58 to a pressure of from any of the following: from 2 to 10 pounds per linear inch, from 2 to 6 pounds per linear inch, and from 4 to 10 pounds per linear inch.

Films 56 and 58 together contact raised surface roller 70 for a distance of about 180 degrees. Raised surface roller 70 has a diameter of 12 inches, is heated by circulating hot oil therethrough so that the surface is maintained at a temperature of from 280° F. to 350° F., and has edges of the raised surfaces being rounded over to a radius of 1/64 inch. Raised surface roll 70 has a Teflon® polytetrafluoroethylene coating thereon, with the raised surfaces being above the background by a distance of ¼ inch (0.64 cm). Moreover, the raised surface of raised surface roll 70 may be provided with a surface roughness of any of the following: from 50 to 500 root mean square (i.e., “rms”), from 100 to 300 rms, and at least 250 rms. This degree of roughness improves the release qualities of raised surface roll 70, enabling faster process speeds and a high quality product which is undamaged by licking back on roll 70.

The raised surface heats that portion of film 58 which contacts the raised surface of roll 70. Heat is transferred from raised surface roll 70, through a heated portion of film 58, to heat a corresponding portion of film 56 to be heat sealed to film 58. Upon passing about 180 degrees around raised surface roll 70, heated films 58 and 56 together pass through second nip 72, which subjects heated films 58 and 56 to about the same pressure as is exerted in first nip 68, resulting in a patterned heat seal between films 56 and 58.

After passing through second nip 72, films 58 and 56, now sealed together, pass about 90 degrees around heat transfer (cooling) roller 74, which has a diameter of 12 inches and which has cooling water passing therethrough, the cooling water having a temperature of from 100° F. to 150° F. Cooling roller 74 has a ¼ inch thick (about 0.64 cm thick) release and heat-transfer coating thereon. The coating is made from a composition designated “SA-B4”, which is provided and applied to a metal roller by Silicone Products and Technologies Inc. of Lancaster, N.Y. The coating contains silicone rubber to provide cooling roller 74 with a Shore A hardness of any of the following: from 40 to 100, from 50 to 80, from 50 to 70, and from 60 to 100. The SA-B4 composition may also contain one or more fillers to increase the heat conductivity to improve the ability of cooling roller 74 to cool the still hot films, now sealed together to result in inflatable article 10, which is thereafter rolled up to form a roll for shipment and subsequent inflation and sealing, to result in a cushioning article.

In order to carry out the process at relatively high speed (e.g., speeds of at least 120 feet per minute, and/or from 150 to 300 feet per minute, and up to as high as 500 feet per minute), it may be advantageous to provide the manufacturing apparatus with several features. The raised surface roll may be provided with a release coating or layer. The raised surface foll may also avoid incorporating sharp edges which may interfere with a clean release of the film from the raised surface roll. As used herein, the phrase “release coating” is inclusive of all release coatings and layers, including polyinfused coatings, applied coatings such as brushed and sprayed coatings which cure on the roll, and even a release tape adhered to the roll. An exemplary release coating composition is Teflon® polytetrafluoroethylene. Second, the edges of the raised surfaces should be rounded off to a radius large enough that the film readily releases without snagging on an edge due to its “sharpness” relative to the softened film. The radius of curvature may be, for example, any of the following: from 1/256 inch to ⅜ inch, from 1/128 inch to 1/16 inch, from 1/100 inch to 1/32 inch, and any of at least 1/64 inch (i.e., about 0.04 cm). The cooling roller may be provided downstream of, and in nip relationship with, the raised surface roller, with a release coating or layer, as described above.

The cooling roller lowers the temperature of the selected heated portions of the laminate, in order to cool the heat seals so that they become strong enough to undergo further processing without being damaged or weakened. Moreover, the cooling may be effected immediately downstream of the heating means (i.e., the raised surface roll), in order to reduce heat seepage from the still-hot seals to unheated portions of film, to prevent unheated portions of laminated article from becoming hot enough to fuse the films in an area intended to serve as an inflation chamber or inflation passageway.

The films used to make the inflatable article may be blown or cast films. Blown films, also referred to as hot blown films, are extruded upwardly from an annular die, and are oriented in the lengthwise and transverse directions while still molten, by blowing the annular extrudate into a bubble (transverse orientation) and drawing on the bubble at a faster rate that the rate of extrusion (machine direction orientation). However, one method of making the film for use in the presently disclosed subject matter is a cast extrusion process in which molten polymer is extruded through a slot die, with the extrudate contacting a chilled roll shortly after extrusion. Both hot blown films and cast films have a total free shrink (i.e., machine direction free shrink plus transverse free shrink) at 85° C. of less than 15 percent as measured by ASTM D 2732; in another embodiment, the hot blown films have total free shrink (i.e., machine direction free shrink plus transverse free shrink) at 85° C. of less than 10 percent as measured by ASTM D2732.

The films referred to herein may comprise a polyolefin, such as for example any of one or more of a low density polyethylene, a homogeneous ethylene/alpha-olefin copolymer (e.g., a metallocene-catalyzed ethylene/alpha-olefin copolymer), a medium density polyethylene, a high density polyethylene, a polyethylene terepthalate, polypropylene, nylon, polyvinylidene chloride (especially methyl acrylate and vinyl chloride copolymers of vinylidene chloride), polyvinyl alcohol, polyamide, or combinations thereof.

Laminate materials 20 may be thin enough to minimize the amount of resin necessary to fabricate laminate materials 20, while thick enough to provide adequate durability. First and second layers film 12 and 13 may have a gauge thickness of any of the following: from about 0.1 to about 20 mils; each film layer may have a total gauge thickness from about 0.5 to about 10 mils, from about 0.8 to about 4 mils, and from about 1.0 to about 3 mils.

If desired or necessary, various additives are also included with the films. For example, additives comprise pigments, colorants, fillers, antioxidants, flame retardants, anti-bacterial agents, anti-static agents, stabilizers, fragrances, odor masking agents, anti-blocking agents, slip agents, and the like. Thus, the presently disclosed subject matter encompasses employing suitable film constituents.

First and second films 12 and 13 may be hot blown films having an A/B/C/B/A structure which has a total thickness of 1.5 mils. The A layers together make up 86 percent of the total thickness, each of the B layers making up 2% of the total thickness, and the C layer making up 10% of the total thickness. The C layer is an O₂-barrier layer of 100% CAPLON® B100WP polyamide 6 having a viscosity of Fav=100, obtained from Allied Chemical. Each of the B layers are tie layers made of 100% PLEXAR® PX165 anhydride modified ethylene copolymer from Quantum Chemical. Each of the A layers are a blend of 45% by weight HCX002 linear low density polyethylene having a density of 0.941 g/cc and a melt index of 4, obtained from Mobil, 45% by weight LF10218 low density polyethylene having a density of 0.918 g/cc and a melt index of 2, obtained from Nova, and 10% by weight SLX9103 metallocene-catalyzed ethylene/alpha-olefin copolymer, obtained from Exxon.

| | | | | Polymer | |
|---|---|---|---|---|---|
| | | | | Melt Index | |
| Resin | | | Density | (dg/min | |
| code | Tradename | Generic Name | (g/cc) | @ 190° C.) | Supplier |
| ssEAO | AFFINITY ® | single site catalyzed very low density | 0.902 g/cc | 3.0 | Dow |
| | PL 1850G | ethylene/octene copolymer | mp: 97° C. | (@ 200 C.) | |
| LLD1 | 2102TX00 | Linear Low density polyethylene | 0.918 g/cc | 0.9 | Sabic |
| | | | mp: 124° C. | | |
| RCYCL | — | Reprocessed film: generally containing | — | — | — |
| | | about 15% polyamide and 85% | | | |
| | | polyethylene | | | |
| HDPE1 | SURPASS ® | High density polyethylene | 0.967 g/cc | 1.20 | Nova |
| | HPs167-AB | | | | Chemicals |
| HDPE2 | SURPASS ® | High density polyethylene | 0.968 g/cc | 6.0 | Nova |
| | HPs667-AB | | | | Chemicals |
| LD1 | 2102TX00 | Low density polyethylene | 0.921 g/cc | 1.9 | Sabic |
| | | | mp: 108° C. | | |
| MDPE | HD3850UA | Heterogeneous ethylene/hexene medium | 0.938 g/cc | 4.5 | Ineos |
| | | density polyethylene | mp: 127° C. | | |
| ENB | TOPAS ® | Ethylene/nothornene copolymer | 1.02 g/cc | 2.04 | Topas |
| | 8700E-400 | | | | Advanced |
| | | | | | Polymers |
| mLLD | PLEXAR ® | Anhydride modified linear low density | 0.921 g/cc | 2.0 | Lyondell/ |
| | 3236 | polyethylene | mp: 125° C. | | Basell Ind. |
| PA1 | ULTRAMID ® | Polyamide 6, lubricated and nucleated | 1.135 g/cc | — | BASF |
| | B36LN | | mp: 220° C. | | |
| MD + AO | NOVAPOL ® | heterogeneous et/hexene medium density | 0.938 g/cc | 4.2 | Nova |
| | TF-038-E | polyethylene with 450 ppm antioxidant | | | Chemicals |
| SLP | POLYBATCHC | Amide wax (erucamide) in low density | 0.92 g/cc | 20.6 | Schulman |
| | E-50SE | polyethylene | | | |
| fl-PA | 100458 | Fluoropolymer in LLDPE | 0.93 g/cc | 2.3 | Ampacet |
| | | (masterbatch with processing aid) | | | |
| AB1 | 101820 | Silica in LDPE and LLDPE | 0.913 g/cc | 1.06 | Ampacet |
| | | (20% ash) | | | |

The laminates formed according to the presently disclosed subject matter can resist popping when pressure is applied to a localized area because channels of air between chambers provide a cushioning effect. The laminates also show excellent creep resistance and cushioning properties due to inter-passage of air between bubbles.

Those skilled in the art will appreciate that numerous changes and modifications may be made to the embodiments described herein, and that such changes and modifications may be made without departing from the spirit of the disclosed inventions of the presently disclosed subject matter.

### Examples

### Table A: Compositions Used in Films

Pairs of various 7-layer coextruded flat films were cast from slot dies. Although all the films had the same basic layer arrangement (seal layer/bulk layer #1/bulk layer #2/tie layer #1/oxygen barrier layer/tie layer #2/abuse layer) a total of 12 different films were made of different combinations of polymeric compositions in the layers. Moreover, in 12 of the films, the two bulk layers were produced as two adjacent microlayer sections each section having 16 microlayers. Another 12 films were produced with the same combination of layer compositions, but each of the bulk layers was a single layer (i.e., no microlayers were present). Still further, each of these 24 different multilayer films was produced in each of three final overall film thicknesses (0.8 mil, 0.6 mil, and 0.4 mil), without altering the wt % of any of the layers. Thus, a total of 72 different films were produced, i.e., 12 polymeric composition variants multiplied by 2 versions (microlayer and non-microlayer) multiplied by 3 different film thicknesses (0.4, 0.6, and 0.8 mil). The 12 different layer arrangements (with layer wt % for each layer) are provided in 12 tables below. Each table discloses both a film with two microlayer sections (one in bulk layer 1, another in bulk layer 2), as well as a corresponding non-microlayer film of the same polymeric composition and layer thicknesses, but with each of the bulk layers lacking microlayers. The actual thickness of each layer is not provided, but can be calculated knowing the final film thickness and layer wt % provided in the tables below, together with information on the density of the polymer in each layer, in the resin table above.

Unless otherwise noted below, two identical webs of each of the 72 different films were heat sealed together, via passage in partial wrap around a heated roller having a raised surface in the pattern of the desired heat seal, and through a nip with a roller in contact with the raised surface of the raised surface roller, in a process as schematically illustrated in FIG. 4B, described above, to produce an inflatable cushioning article. The raised surface roller pattern produced inflatable chambers having a length of 15.5 inches before inflation (12.25 inches after inflation), with, in alternating rows, a total of 9.5 or 10 cells per chamber, with each cell having a diameter of 1.24 inch before inflation. Moreover, the resulting sealed web was provided with a transverse line of perforations to weaken the sealed web between chambers (so that individual “sheets” could be readily torn off a roll of material, for ease of use in packaging applications), with the perforations being provided after every 10 chambers. The distance between perforations was 12.75 inches before inflation, but only 10 inches after inflation. Inflation of each chamber was carried out to the extent that the inflated cells had an average height of 0.597 inch (1.52 cm). The resulting inflatable cellular cushioning articles and films thereof were tested for burst strength, altitude survival, tensile elongation (unsealed films only, as described below), compressive strength, and predictive time-to-failure. Test data together with interpretation of results are provided in various tables below.

Film No. 1M & Film No. 1NM

| Layer 1 | Layer 2* | Layer 3* | Layer 4 | Layer 5 | Layer 6 | Layer 7 |
|---|---|---|---|---|---|---|
| (seal) | (bulk 1) | (bulk 2) | (tie) | (nylon) | (tie) | (abuse) |
| 40% LD1 | 42.5% LD1 | 42.5% LD1 | 100% | 100% | 100% | 20% LD1 |
| 40% MD + AO | 42.5% MDPE | 42.5% MD + AO | mLLD | PA1 | mLLD | 60% MD + AO |
| 15% LLD1 | 15% LLD1 | 15% LLD1 | | | | 15% LLD1 |
| 2% AB1 | | | | | | 2% AB1 |
| 2% fl-PA | | | | | | 2% fl-PA |
| 1% SLP | | | | | | 1% SLP |
| 15 wt % | 25.5 wt % | 25.5 wt % | 2 wt % | 15 wt % | 2 wt % | 15 wt % |

*= section composed of 16 microlayers in Film 1M;
*= single layer in Film 1NM

Film No. 2M & Film No. 2NM

| Layer 1 | Layer 2* | Layer 3* | Layer 4 | Layer 5 | Layer 6 | Layer 7 |
|---|---|---|---|---|---|---|
| (seal) | (bulk 1) | (bulk 2) | (tie) | (nylon) | (tie) | (abuse) |
| 40% LD1 | 42.5% LD1 | 42.5% LD1 | 100% | 100% | 100% | 20% LD1 |
| 40% MD + AO | 42.5% MD + AO | 42.5% MD + AO | mLLD | PA1 | mLLD | 60% MD + AO |
| 15% LLD1 | 15% LLD1 | 15% LLD1 | | | | 15% LLD1 |
| 2% AB1 | | | | | | 2% AB1 |
| 2% fl-PA | | | | | | 2% fl-PA |
| 1% SLP | | | | | | 1% SLP |
| 15 wt % | 30.5 wt % | 25.5 wt % | 2 wt % | 10 wt % | 2 wt % | 15 wt % |

*= section composed of 16 microlayers in Film 2M;
*= single layer in Film 2NM

Film No. 3M & Film No. 3NM

| Layer 1 | Layer 2* | Layer 3* | Layer 4 | Layer 5 | Layer 6 | Layer 7 |
|---|---|---|---|---|---|---|
| (seal) | (bulk 1) | (bulk 2) | (tie) | (nylon) | (tie) | (abuse) |
| 40% LD1 | 42.5% LD1 | 42.5% LD1 | 100% | 100% | 100% | 20% LD1 |
| 40% MD + AO | 42.5% MD + AO | 42.5% MD + AO | mLLD | PA1 | mLLD | 60% MD + AO |
| 15% LLD1 | 15% LLD1 | 15% LLD1 | | | | 15% LLD1 |
| 2% AB1 | | | | | | 2% AB1 |
| 2% fl-PA | | | | | | 2% fl-PA |
| 1% SLP | | | | | | 1% SLP |
| 15 wt % | 35.5 wt % | 25.5 wt % | 2 wt % | 5 wt % | 2 wt % | 15 wt % |

*= section composed of 16 microlayers in Film 3M;
*= single layer in Film 3NM

Film No. 4M & Film No. 4NM

| Layer 1 | Layer 2* | Layer 3* | Layer 4 | Layer 5 | Layer 6 | Layer 7 |
|---|---|---|---|---|---|---|
| (seal) | (bulk 1) | (bulk 2) | (tie) | (nylon) | (tie) | (abuse) |
| 40% LD1 | 42.5% LD1 | 60% HDPE1 | 100% | 100% | 100% | 20% LD1 |
| 40% MD + AO | 42.5% MD + AO | 40% HDPE2 | mLLD | PA1 | mLLD | 60% MD + AO |
| 15% LLD1 | 15% LLD1 | | | | | 15% LLD1 |
| 2% AB1 | | | | | | 2% AB1 |
| 2% fl-PA | | | | | | 2% fl-PA |
| 1% SLP | | | | | | 1% SLP |
| 15 wt % | 25.5 wt % | 25.5 wt % | 2 wt % | 15 wt % | 2 wt % | 15 wt % |

*= section composed of 16 microlayers in Film 4M;
*= single layer in Film 4NM

Film No. 5M & Film No. 5NM

| Layer 1 | Layer 2* | Layer 3* | Layer 4 | Layer 5 | Layer 6 | Layer 7 |
|---|---|---|---|---|---|---|
| (seal) | (bulk 1) | (bulk 2) | (tie) | (nylon) | (tie) | (abuse) |
| 40% LD1 | 42.5% LD1 | 60% HDPE1 | 100% | 100% | 100% | 20% LD1 |
| 40% MD + AO | 42.5% MD + AO | 40% HDPE2 | mLLD | PA1 | mLLD | 60% MD + AO |
| 15% LLD1 | 15% LLD1 | | | | | 15% LLD1 |
| 2% AB1 | | | | | | 2% AB1 |
| 2% fl-PA | | | | | | 2% fl-PA |
| 1% SLP | | | | | | 1% SLP |
| 15 wt % | 30.5 wt % | 25.5 wt % | 2 wt % | 10 wt % | 2 wt % | 15 wt % |

*= section composed of 16 microlayers in Film 5M;
*= single layer in Film 5NM

Film No. 6M & Film No. 6NM

| Layer 1 | Layer 2* | Layer 3* | Layer 4 | Layer 5 | Layer 6 | Layer 7 |
|---|---|---|---|---|---|---|
| (seal) | (bulk 1) | (bulk 2) | (tie) | (nylon) | (tie) | (abuse) |
| 40% LD1 | 42.5% LD1 | 60% HDPE2 | 100% | 100% | 100% | 20% LD1 |
| 40% MD + AO | 42.5% MD + AO | 40% HDPE3 | mLLD | PA1 | mLLD | 60% MD + AO |
| 15% LLD1 | 15% LLD1 | | | | | 15% LLD1 |
| 2% AB1 | | | | | | 2% AB1 |
| 2% fl-PA | | | | | | 2% fl-PA |
| 1% SLP | | | | | | 1% SLP |
| 15 wt % | 35.5 wt % | 25.5 wt % | 2 wt % | 5 wt % | 2 wt % | 15 wt % |

*= section composed of 16 microlayers in Film 6M;
*= single layer in Film 6NM

Film No. 7M & Film No. 7NM

| Layer 1 | Layer 2* | Layer 3* | Layer 4 | Layer 5 | Layer 6 | Layer 7 |
|---|---|---|---|---|---|---|
| (seal) | (bulk 1) | (bulk 2) | (tie) | (nylon) | (tie) | (abuse) |
| 40% LD1 | 32.5% LD1 | 60% HDPE1 | 100% | 100% | 100% | 20% LD1 |
| 40% MD + AO | 32.5% MD + AO | 40% HDPE2 | mLLD | PA1 | mLLD | 60% MD + AO |
| 15% LLD1 | 15% LLD1 | | | | | 15% LLD1 |
| 2% AB1 | 20% RCYCL | | | | | 2% AB1 |
| 2% fl-PA | | | | | | 2% fl-PA |
| 1% SLP | | | | | | 1% SLP |
| 12.5 wt % | 40.5 wt % | 25.5 wt % | 2 wt % | 5 wt % | 2 wt % | 12.5 wt % |

*= section composed of 16 microlayers in Film 7M;
*= single layer in Film 7NM

Film No. 8M & Film No. 8NM

| Layer 1 | Layer 2* | Layer 3* | Layer 4 | Layer 5 | Layer 6 | Layer 7 |
|---|---|---|---|---|---|---|
| (seal) | (bulk 1) | (bulk 2) | (tie) | (nylon) | (tie) | (abuse) |
| 40% LD1 | 22.5% LD1 | 60% HDPE1 | 100% | 100% | 100% | 20% LD 1 |
| 40% MD + AO | 22.5% MD + AO | 40% HDPE2 | mLLD | PA1 | mLLD | 60% MD + AO |
| 15% LLD1 | 10% LLD1 | | | | | 15% LLD1 |
| 2% AB 1 | 45% RCYCL | | | | | 2% AB 1 |
| 2% fl-PA | | | | | | 2% fl-PA |
| 1% SLP | | | | | | 1% SLP |
| 12.5 wt % | 40.5 wt % | 25.5 wt % | 2 wt % | 5 wt % | 2 wt % | 12.5 wt % |

*= section composed of 16 microlayers in Film 8M;
*= single layer in Film 8NM

Film No. 9M & Film No. 9NM

| Layer 1 | Layer 2* | Layer 3* | Layer 4 | Layer 5 | Layer 6 | Layer 7 |
|---|---|---|---|---|---|---|
| (seal) | (bulk 1) | (bulk 2) | (tie) | (nylon) | (tie) | (abuse) |
| 40% LD1 | 22.5% LD1 | 15% LLD1 | 100% | 100% | 100% | 20% LD1 |
| 40% MD + AO | 22.5% MD + AO | 40% HDPE1 | mLLD | PA1 | mLLD | 60% MD + AO |
| 15% LLD1 | 10% LLD1 | 45% HDPE2 | | | | 15% LLD1 |
| 2% AB1 | 45% RCYCL | | | | | 2% AB1 |
| 2% fl-PA | | | | | | 2% fl-PA |
| 1% SLP | | | | | | 1% SLP |
| 12.5 wt % | 40.5 wt % | 25.5 wt % | 2 wt % | 5 wt % | 2 wt % | 12.5 wt % |

*= section composed of 16 microlayers in Film 9M;
*= single layer in Film 9NM

Film No. 10M & Film No. 10NM

| Layer 1 | Layer 2* | Layer 3* | Layer 4 | Layer 5 | Layer 6 | Layer 7 |
|---|---|---|---|---|---|---|
| (seal) | (bulk 1) | (bulk 2) | (tie) | (nylon) | (tie) | (abuse) |
| 40% LD1 | 35% LD1 | 80% ssEAO | 100% | 100% | 100% | 20% LD1 |
| 40% MD + AO | 20% MD + AO | 20% LLD1 | mLLD | PA1 | mLLD | 60% MD + AO |
| 15% LLD1 | 45% RCYCL | | | | | 15% LLD1 |
| 2% AB1 | | | | | | 2% AB1 |
| 2% fl-PA | | | | | | 2% fl-PA |
| 1% SLP | | | | | | 1% SLP |
| 12.5 wt % | 40.5 wt % | 20.5 wt % | 2 wt % | 10 wt % | 2 wt % | 12.5 wt % |

*= section composed of 16 microlayers in Film 10M;
*= single layer in Film 10NM

Film No. 11M & Film No. 11NM

| Layer 1 | Layer 2* | Layer 3* | Layer 4 | Layer 5 | Layer 6 | Layer 7 |
|---|---|---|---|---|---|---|
| (seal) | (bulk 1) | (bulk 2) | (tie) | (nylon) | (tie) | (abuse) |
| 40% LD1 | 100% LD1 | 60% ENB | 100% | 100% | 100% | 20% LD1 |
| 40% MD + AO | | 40% LD1 | mLLD | PA1 | mLLD | 60% MD + AO |
| 15% LLD1 | | | | | | 15% LLD1 |
| 2% AB1 | | | | | | 2% AB1 |
| 2% fl-PA | | | | | | 2% fl-PA |
| 1% SLP | | | | | | 1% SLP |
| 15 wt % | 38 wt % | 13 wt % | 2 wt % | 15 wt % | 2 wt % | 15 wt % |

*= section composed of 16 microlayers in Film 11M;
*= single layer in Film 11NM

Film No. 12M & Film No. 12NM

| Layer 1 | Layer 2* | Layer 3* | Layer 4 | Layer 5 | Layer 6 | Layer 7 |
|---|---|---|---|---|---|---|
| (seal) | (bulk 1) | (bulk 2) | (tie) | (nylon) | (tie) | (abuse) |
| 40% LD1 | 100% LD1 | 65% MD + AO | 100% | 100% | 100% | 20% LD1 |
| 40% MD + AO | | 35% LLD1 | mLLD | PA1 | mLLD | 60% MD + AO |
| 15% LLD1 | | | | | | 15% LLD1 |
| 2% AB1 | | | | | | 2% AB1 |
| 2% fl-PA | | | | | | 2% fl-PA |
| 1% SLP | | | | | | 1% SLP |
| 15 wt % | 40.5 wt % | 20.5 wt % | 2 wt % | 5 wt % | 2 wt % | 15 wt % |

*= section composed of 16 microlayers in Film 12M;
*= single layer in Film 12NM

The twenty four different film formulations set forth above (1M-12M and 1 NM-12 NM) were produced and thereafter converted into inflatable cushioning articles in the process illustrated in FIG. 4B (described above), resulting in an inflatable article as illustrated in FIG. 1, described above. Each of the resulting 24 cushioning articles was made by extruding two discrete films from a multilayer stacked slot die. For each inflatable article, the two films were “identical” to the extent that the two films: (i) had the same number of layers, (ii) had the same layer arrangement, (iii) had the same layer thickness, and (iv) had the same layer composition. However, each of the two discrete, “identical” films was extruded from its own designated multilayer stacked slot die. The multilayer stacked slot die for each of the “M” films included two core microlayer sections each made from 16 microlayers. The multilayer stack slot die for each of the “NM” films included two discrete core layers, rather than the two core microlayer sections each containing 16 microlayers. For each of the inflatable articles tested, the two identical films were sealed together in the process illustrated in FIG. 2, described above.

### The Burst Pressure Test

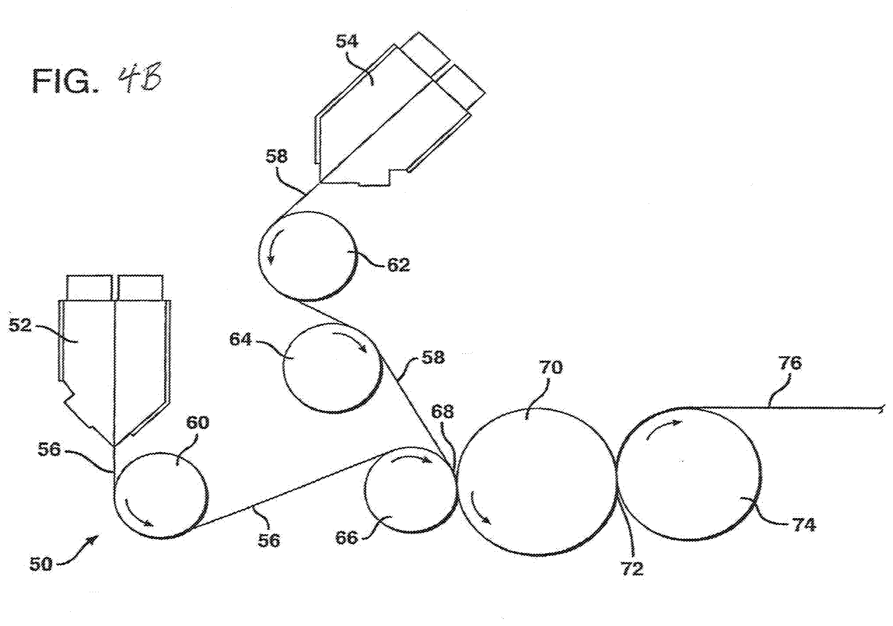

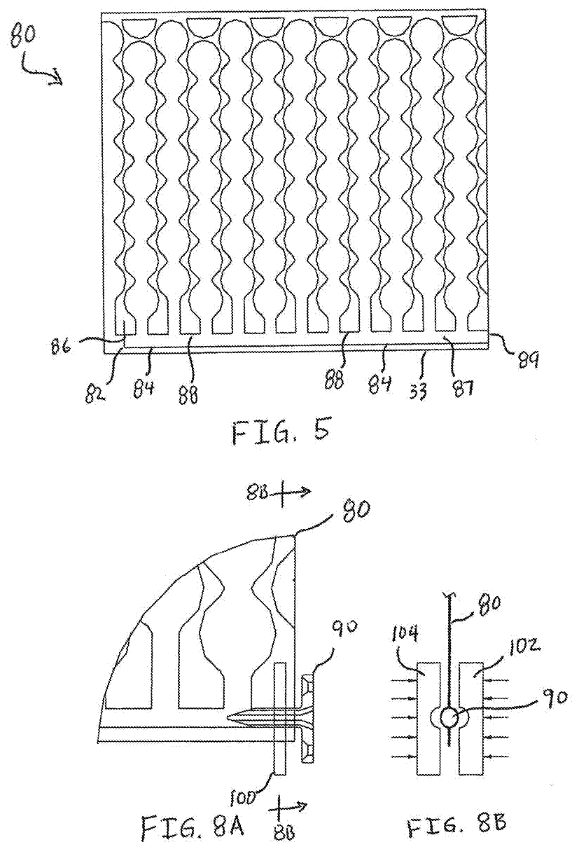

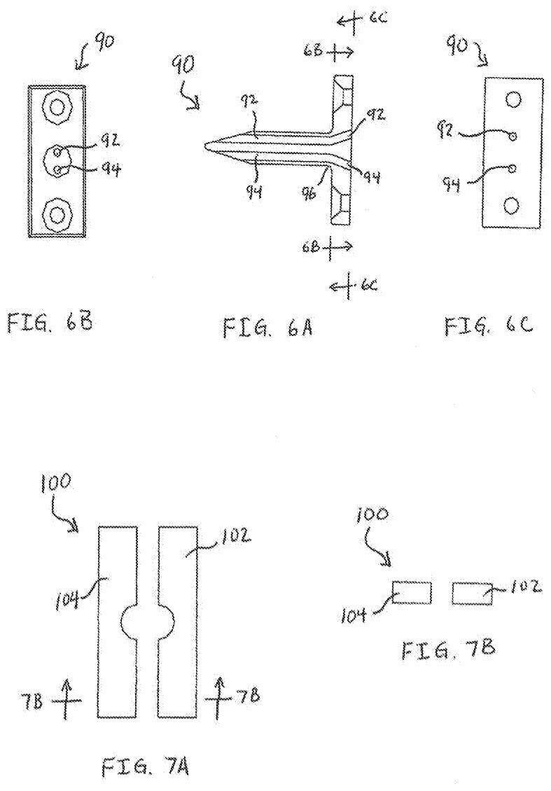

The Burst Pressure Test was carried out using a [Bubble] Pop Tester/[IB] Pop Tester System obtained from Catbridge, of Parsippany, N.J. The Burst Pressure Test was carried out on a section of the inflatable article 80 which was modified with additional seal 82, as shown in FIG. 5. Seal 82 is a heat seal, and is made up of longitudinal heat seal portion 84 and transverse heat seal portion 86. Longitudinal seal portion 84 runs parallel to edge 33, and is spaced a desired distance from seal edges 88 to provide inflation passageway 87, so that inflation nozzle 90 (see FIGS. 6A, 6B, and 6C) can be inserted and fit snugly against the inside surface thereof. Inflation nozzle 90 has mirror-image passageways 92 and 94 therewithin, with one passageway being connected to a source of compressed air, while the other is connected to a pressure gauge. Passageways 92 and 94 each have a diameter of 3/32 inch. Inflation nozzle 90 is inserted into passageway 87 until inflation nozzle base portion 96 contacts film edge 89. Then clamp 100 (see FIG. 7A and FIG. 7B) is placed over that portion of the film around passageway 87 which covers cylindrical portion 98 of inflation nozzle 90. Cylindrical portion 98 has a diameter of % inch.

As shown in FIGS. 7A and 7B, clamp cauls 100, which comprise upper clamp caul 102 and lower clamp caul 104, are used to hold the films of inflatable article 80 firmly against inflation nozzle 90, in the position illustrated in FIGS. 8A and 8B. The device for applying force to hold clamping cauls 100 firmly against inflation nozzle 90 is not illustrated, but can be any means known to those of skill in the art, such as a C-clamp, bar clamp, spring clamp, hydraulic clamp, etc. When forced firmly against film 80 as illustrated in FIGS. 8A and 8B, clamping cauls 100 reduce or eliminate backflow of compressed air past inflation nozzle 90 and out of passageway 87. It should be noted that transverse seal portion 86 serves to provide a closed end to passageway 87, so that upon addition of compressed air from inflation nozzle 90, eleven chambers were simultaneously inflated until the article burst.

During the Burst Pressure Test, compressed air was provided to the inflation nozzle at 20 psi, using a pressure regulator, with airflow being controlled by a throttling device (e.g., orifice, needle valve, etc.) to 0.2 standard cubic feet per minute at free flow. The test was carried out while the inflatable article was at 23° C. and while the ambient pressure surrounding the inflatable article was 1 atmosphere. When the inflatable article ruptured, the peak pressure was recorded.

As used herein, the phrases “burst pressure,” “failure pressure,” and the term “burst,” refer to the pressure at which the inflatable article “fails” when inflated in accordance with the Burst Pressure Test described with the examples below. The article “fails” if either film bursts, or exhibits seal failure or delamination which is immediately apparent to the unaided eye, i.e., not including trace seal failure or trace delamination. The failure pressure is determined by inflating the article while the article is in an environment of 1 atmosphere ambient pressure and 25° C. ambient temperature.

### Burst Pressure Test Results

Table 1, below, provides the burst pressures for the inflatable articles. A comparison of the inflated articles made with the microlayered film sections against the inflated articles made with the corresponding non-microlayered films demonstrated that the articles made from the films containing microlayered sections exhibited consistently higher burst strength than the articles made from the corresponding non-microlayered films. Moreover, statistical analysis revealed that the higher burst strength exhibited by the inflated cushioning article made from films containing microlayers is statistically significant over the relatively lower burst strength exhibited by the inflated cushioning articles made from the corresponding films which did not contain microlayers.

### Altitude Survival Test

The Altitude Survival Test (herein “AST”) was carried out in accordance with ASTM D6653, which is hereby incorporated, in its entirety, by reference thereto. The AST was used to simulate the effect of low ambient pressure on the inflated cushioning article when packaged products are transported by airplane at high altitude, with the inflated cushioning article serving as cushioning, dunnage, and/or void fill in a package. The AST was carried out by inflating a sheet of the cushioning article followed by sealing the inflated chambers closed. Each sheet contained 10 chambers, with 5 of the chambers containing 10 inflatable cells and 5 of the chambers containing 9½ of the inflatable cells, with the cells (and the half cells) being connected in series in fluid communication with each other via a series of 9 inter-cell connecting channels plus a skirt-to-first-cell connecting channel connecting the first cell to the inflation skirt. The inflatable article was inflated to the degree that the average bubble height after inflation was 0.597 inch (1.52 cm), with the inflation being carried out while the ambient pressure was 760 mm Hg and the ambient temperature was 73° F. The inflated article was then placed in a chamber with pressure reduced to 13.7 inches Hg (i.e., 348 mm Hg, which is 0.458 atmosphere) for a period of two minutes. For each data point, the test was carried out with 4 sheets, with each sheet containing individual sealed chambers. Moreover, the test was repeated 10 times with the results averaged, with the average value being reported in the table below. The AST test results are reported as “% inflated,” which represents the number of sealed chambers that did not burst during the test, divided by the total number of chambers tested, with the resulting quotient multiplied by 100 to provide the % of chambers that remained inflated upon completion of the AST.

### Altitude Survival Test Results

In the AST, the cushioning articles made from the films having microlayers exhibited significantly higher survival rates than the corresponding non-microlayer films. More particularly, the cushioning articles made from the films containing microlayers exhibited significantly better altitude survival rate for samples with: (i) a polyamide content of from 3 to 12 wt % on a total film weight basis (hereinafter “tfb”), a total film thickness of from 0.2 to 0.7 mil, and a recycle content of from 0 to 20 wt %, tfb; (ii) a polyamide content of from 4 to 11 wt % tfb, a total film thickness of from 0.3 to 0.6 mil, and a recycle content of from 0 to 15 wt %, tfb; (iii) a polyamide content of from 5 to 10 wt % tfb, a total film thickness of from 0.35 to 0.45 mil, and a recycle content of from 0 to 12 wt %, tfb.

TABLE 1
Burst Strength and Altitude Survival

| | | | | | Altitude Survival | | |
|---|---|---|---|---|---|---|---|
| | Thickness | Burst [psi] | | % | [% inflated] | | % |
| | [mil] | Microlayered | Control | increase | Microlayered | Control | increase |
| Film No. 1M vs. | 0.8 | 5.615 | 5.04 | 13.2 | 99.38 | 96.88 | 2.6 |
| Film No. 1NM | 0.6 | 4.480 | 4.420 | 1.4 | 99.50 | 99.60 | −0.1 |
| (films contain | 0.4 | 3.590 | 3.450 | 4.1 | 99.25 | 80.00 | 24.1 |
| 15% nylon) | | | | | | | |
| Film No. 2M vs. | 0.8 | 5.19 | 5.12 | 1.3 | 98.5 | 94.25 | 4.5 |
| Film No. 2NM | 0.6 | 4.450 | 4.205 | 5.8 | 99.90 | 99.13 | 0.8 |
| (films contain | 0.4 | 3.405 | 3.335 | 2.1 | 79.75 | 81.75 | −2.4 |
| 10% nylon) | | | | | | | |
| Film No. 3M vs. | 0.8 | 5.025 | 4.915 | 0.7 | 99.38 | 95.88 | 3.6 |
| Film No. 3NM | 0.6 | 4.210 | 4.105 | 2.6 | 99.30 | 95.93 | 3.5 |
| (films contain | 0.4 | 3.295 | 3.030 | 8.7 | 96.37 | 43.63 | 98.2 |
| 5% nylon) | | | | | | | |
| Film No. 4M vs. | 0.8 | 5.5 | 5.145 | 3.1 | 97.50 | 91.50 | 6.6 |
| Film No. 4NM | 0.6 | 4.445 | 4.105 | 8.3 | 95.63 | 72.38 | 32.1 |
| Films contain | 0.4 | — | — | — | — | — | — |
| 15% nylon | | | | | | | |
| 25.5% HDPE | | | | | | | |
| Film No. 5M vs. | 0.8 | 5.22 | 5.175 | 1.5 | 96.88 | 85.75 | 13.0 |
| Film No. 5NM | 0.6 | 4.115 | 4.100 | 0.4 | 85.88 | 70.13 | 22.6 |
| Films contain | 0.4 | 3.270 | 3.210 | 1.9 | 69.00 | 52.38 | 31.7 |
| 10% nylon | | | | | | | |
| 25.5% HDPE | | | | | | | |
| Film No. 6M vs. | 0.8 | 5.28 | 4.9 | 5.9 | 94.13 | 83.88 | 12.2 |
| Film No. 6NM | 0.6 | 4.250 | 4.055 | 4.8 | 96.00 | 63.68 | 50.1 |
| Films contain | 0.4 | 3.105 | 2.910 | 6.7 | 40.38 | 1.13 | 3,570 |
| 5% nylon | | | | | | | |
| 25.5% HDPE | | | | | | | |
| Film No. 7M vs. | 0.8 | 5.06 | 4.925 | 1.9 | 93.63 | 84.00 | 11.5 |
| Film No. 7NM | — | — | — | — | — | — | — |
| Films contain: | | | | | | | |
| 5% nylon | | | | | | | |
| 25.5% HDPE | | | | | | | |
| 5% regrind | | | | | | | |
| Film No. 8M vs. | 0.8 | 5.14 | 4.935 | 3.6 | 92.75 | 79.50 | 16.7 |
| Film No. 8NM | 0.6 | 4.050 | 3.660 | 10.7 | 96.13 | 13.63 | 705 |
| Films contain: | 0.4 | 2.730 | 2.750 | −0.7 | 7.13 | 0.00 | *** |
| 5% nylon | | | | | | | |
| 25.5% HDPE | | | | | | | |
| 11% regrind | | | | | | | |
| Film No. 9M vs. | 0.8 | 5.055 | 4.93 | 2.7 | 95.50 | 80.00 | 19.4 |
| Film No. 9NM | 0.6 | 4.160 | 3.69 | 12.7 | 85.38 | *** | *** |
| Films contain: | 0.4 | 2.610 | 2.64 | −1.1 | 41.25 | 0.00 | *** |
| 5% nylon | | | | | | | |
| 25.5%(HDPE/ | | | | | | | |
| LLDPE 85/15) | | | | | | | |
| 11% regrind | | | | | | | |
| Film No. 10M vs. | 0.8 | 4.64 | 4.355 | 6.1 | 94.75 | 90.13 | 5.1 |
| Film No. 10NM | | | | | | | |
| Films contain: | | | | | | | |
| 10% nylon | | | | | | | |
| Film No. 11M vs. | 0.8 | 4.43 | 3.875 | 18.3 | 94.75 | **** | *** |
| Film No. 11NM | | | | | | | |
| Films contain: | | | | | | | |
| 10% nylon | | | | | | | |
| 11% regrind | | | | | | | |
| Film No. 12M vs. | 0.8 | 4.66 | 4.62 | −0.7 | 97.63 | | *** |
| Film No. 12NM | 0.6 | 3.740 | 3.670 | 1.9 | 82.75 | 71.50 | 15.7 |
| Films contain: | 0.4 | 2.765 | 2.465 | 12.2 | 19.25 | 14.00 | 37.5 |
| 5% nylon | | | | | | | |
| 11% regrind | | | | | | | |

Made from Films (“M”) Containing Microlayers vs. Films Not Containing Microlayers (“NM”)

### Transverse Direction Film Elongation Test

The Transverse Direction Film Elongation Test (“TD Elongation Test”) was carried out in accordance with ASTM D882, which is hereby incorporated, in its entirety, by reference thereto. Six sets of film pairs (i.e., each set consisting of a pair of identical microlayered films and another pair of corresponding non-microlayered films, for a total of 24 films of 12 different types) were produced and double wound onto a roll rather than sealed to each other to form the inflatable article. From each of the films, four 7.62 cm long, 2.54 cm wide film samples were taken from the roll. For each sample, the 7.62 cm sample length ran in the transverse direction. Each film sample was then mounted in an INSTRON® Model No. 5564 and was drawn in the direction of the sample length (i.e., the film of the sample was drawn the in its transverse direction, relative to the manner in which the film was produced) with the crosshead of the machine set at a draw rate of 20 inches per minute. The sample was drawn until it broke. The % elongation values, as reported in the Table below, were determined by subtracting the original sample length between the INSTRON mounts from the final sample length (i.e., length of sample when it broke) and dividing this difference by the original length of the sample, then multiplying the quotient by 100. The resulting value represented the TD elongation percentage for the sample. Each value reported in Table 2 (below) represents an average of 4 samples tested, these samples being taken from the same film in the same manner. The test was conducted with the sample at 73° F.

The six sets of film pairs selected for the TD Elongation Test included (i) first three film sets each containing 15 wt % polyamide (total film weight basis), all of the same formulation except that one was 0.8 mil thick, another 0.6 mil thick and the last 0.4 mil thick, and, (ii) second three film sets each containing 5 wt % polyamide (total film weight basis), all of the same formulation except that one was 0.8 mil thick, another 0.6 mil thick and the last 0.4 mil thick.

TABLE 2
Film TD Elongation

| | | | Microlayered | Non-Microlayered | |
|---|---|---|---|---|---|
| Films of | Nylon | Thickness | TD Elongation | TD Elongation | % Increase in |
| Ex. No. | (%) | (mil, avg) | (%) | (%) | TD elongation |
| 1M | 15 | 0.8 | 380, 420, 420, 390 | 380, 400, 420, 370 | 2.6 |
| 1NM | | | avg 402.5 | avg 392.5 | |
| 1M | | 0.6 | 430, 430, 400, 350 | 380, 380, 370, 430 | 10.1 |
| 1NM | | | Avg 402.5 | Avg 365 | |
| 1M | | 0.4 | 360, 360, 400, 400 | 390, 420, 5.1^{#}, 5.4^{#} | 265 |
| 1NM | | | Avg 380 | Avg 104^{#} | |
| 3M | 35 | 0.8 | 500, 460, 460 | 440, 440, 450, 440 | 7.0 |
| 3NM | | | Avg 473 | Avg 442 | |
| 3M | | 0.6 | 470, 430, 440, 430 | 6.4^{#}, 6.4^{#}, 6.4^{#}, 6.4^{#} | 6,906 |
| 3NM | | | Avg 442 | Avg 6.4^{#} | |
| 3M | | 0.4 | 460, 440, 5.8^{#}, 5.7^{#}, | 6.1^{#}, 6.4^{#}, 5.7^{#}, 6.4^{#} | 2,406 |
| 3NM | | | 5.7^{#}, 5.1^{#} | Avg 6.4 | |
| | | | Avg 154 | | |

#broke at initial yield

### TD Elongation Test Results

As shown in the table above, all films containing microlayers with 15% nylon in the structure underwent elongation in the transverse direction to a level of about 400%, on average. Non-microlayered films showed similar elongation in film having a thickness of 0.8 and 0.6 mil. However when the thickness was reduced to 0.4 mil, half of the non-microlayered test specimens broke at yield. Of the non-microlayered films, only the 0.8 mil thick film samples elongated to 400%. All test specimens of 0.6 mil and 0.4 mil failed to elongate and broke at yield (i.e., underwent only about 6% yield before breaking). Microlayering improved the TD elongation for reduced nylon samples. All of the microlayer-containing films underwent transverse direction orientation to a level of about 400%, including the 0.8 mil, 0.6 mil and some of 0.4 mil thick films.

Although a reduction in polyamide content from 15 wt % to 5 wt % (total film weight basis) was also found to reduce film's tensile strength, elongation and barrier properties, surprisingly a clear difference between microlayered and corresponding non-microlayer films was discovered to exist in the area of TD elongation of films of thinner gauge. It was further found that the machine direction (MD) elongation of the films with microlayers was statistically the same as the MD elongation of the corresponding films without microlayers.

Although the % TD elongation between films with and without microlayers was about the same for films having a thickness of about 0.8 mil, for the films having a thickness of 0.6 and 0.4 mils, microlayering was surprisingly found to improve % TD elongation. These thinner microlayer-containing films with greater % TD elongation were believed to possess greater strength than their non-microlayer counterparts, and were believed to correspond with greater bubble strength once the inflatable cushioning article was inflated, relative to inflatable articles produced using their non-microlayer counterparts. The significant improvement in % TD Elongation of the thinner films with microlayers (e.g., from 0.2 mil to 0.7 mil, or from 0.3 to 0.65 mil, or from 0.4 to 0.6 mil) versus their non-microlayer containing counterparts was surprising and unexpected. Moreover, the higher elongation should correlate with higher bubble strength which should allow the film to be produced at lower gauge while maintaining the bubble strength properties of a thicker film lacking microlayers.

Compressive Resistance Test

The Compressive Resistance Test was carried out in accordance with ASTM D3575, Standard Test Methods for Flexible Cellular Materials Made from Olefin Polymers and ASTM D642, Standard Test Method for Determining Compressive Resistance of Shipping Containers, Components, and Unit Loads, which is hereby incorporated, in its entirety, by reference thereto. Six sets of film pairs (i.e., each set consisting of a pair of identical microlayered films and a pair of corresponding non-microlayered films) were produced and sealed together to make 12 different inflatable articles. The twelve inflatable cushioning articles were inflated to a thickness of 0.597 inch (1.52 cm), sealed closed, and subjected to compressive resistance testing in accordance with ASTM D3575 and ASTM D642, with the results as set forth in the table below.

TABLE 3
Compressive Resistance

| | | | | | | % increase of |
|---|---|---|---|---|---|---|
| | | | | | | microlayered |
| Inflated | | | | | Avg. Max. | sample |
| Article made | Gauge | Nylon | RCYCL | Microlayered | Compression | over non- |
| from Film | (mils) | (%) | (%) | (Y/N) | Force (lbf) | microlayered |
| 2M | 0.4 | 10 | 0 | Y | 732 | 46.7 |
| 2NM | 0.4 | 10 | 0 | N | 499 | n/a |
| 2M | 0.6 | 10 | 0 | Y | 1014 | 52.9 |
| 2NM | 0.6 | 10 | 0 | N | 663 | n/a |
| 6M | 0.4 | 5 | 0 | Y | 688 | 19.8 |
| 6NM | 0.4 | 5 | 0 | N | 574 | n/a |
| 6M | 0.6 | 5 | 0 | Y | 1255 | 18.4 |
| 6NM | 0.6 | 5 | 0 | N | 1060 | n/a |
| 8M | 0.4 | 5 | 11 | Y | 564 | 1.4 |
| 8NM | 0.4 | 5 | 11 | N | 556 | n/a |
| 8M | 0.6 | 5 | 11 | Y | 1038 | 9.3 |

The Compressive Strength test results show an unexpected increase in compression strength for the inflated cushioning articles made from the films having microlayers relative to the comparative cushioning articles made from corresponding films without microlayers. More particularly, at a 10% polyamide level (tfb) and 0% recycle (tfb), with the recycle material being prepared by recycling film of the same type, with the recycle material being located in the core layers) in the films, the average maximum compression force increased 46.7% for articles made from films 0.4 mil thick and 52.9% for films 0.6 mil thick. At a 5% polyamide level (tfb) and 0% recycle (tfb) in the films, the average maximum compression force increased 19.8% for articles made from films 0.4 mil thick and 18.4% for articles made from films 0.6 mil thick. At a 5% polyamide level (tfb) and 11% (tfb) recycle in the films, the average maximum compression force increased 1.4% for articles made from films 0.4 mil thick and 9.3% for articles made from films 0.6 mil thick.

Based on the results above, it was surmised that an unexpectedly high increase in compressive strength is obtainable from an inflatable article made from: film having a microlayer section making up from 30 to 80 wt % (tfb), the film containing polyamide in an amount of from 2 to 20 wt % (tfb) with the film having a total thickness of from 0.2 to 1.2 mils, with the film containing from 0 to 6% recycle (tfb); or film having a microlayer section making up from 35 to 75 wt % (tfb), the film containing polyamide in an amount of from 3 to 15 wt % (tfb) with the film having a total thickness of from 0.3 to 1 mil, with the film containing 0 to 5% recycle (tfb); or film having a microlayer section making up from 40 to 70 wt % (tfb), the film containing polyamide in an amount of from 4 to 12 wt % (tfb) with the film having a total thickness of from 0.3 to 0.9 mil, with the film containing less than 5% recycle (tfb); or film having a microlayer section making up from 45 to 65 wt % (tfb), the film containing polyamide in an amount of from 4 to 12 wt % (tfb) with the film having a total thickness of from 0.4 to 0.8 mil, with the film containing less than 3% recycle (tfb).

### Predictive Time-to-Failure Evaluation

The compression strength data was used to in a predictive model to determine the time-to-failure for the inflated cushioning article. The model was INSTRON® 5900R. Results from these predictive models showed the microlayered structures had a longer duration in time-to-failure than the non-microlayered structures. Based on 5%* of the compression strength load, the microlayered samples could last up to 12.8 days whereas the non-microlayered samples would be considered failed by as early as 7.9 days. The table below provides the details for the results from the predictive model.

TABLE 4
Time-to-failure Prediction
Predicted Time (days)

| | | Film 6NM | | Film 2NM |
|---|---|---|---|---|
| | Film 6M | 0.6 mil | Film 2M | 0.6 mil |
| | 0.6 mil | 5% nylon | 0.6 mil | 10% nylon |
| | 5% nylon | 0% repro | 10% nylon | 0% repro |
| Load | 0% repro | Non- | 0% repro | Non- |
| (% CS) | microlayered | microlayered | microlayered | microlayered |
| 1 | 66.4 | 41.2 | 66.6 | 53.8 |
| 5* | 12.7 | 7.9 | 12.8 | 10.3 |
| 20 | 2.7 | 1.7 | 2.7 | 2.2 |
| 40 | 1.0 | 0.6 | 1.0 | 0.8 |
| 60 | 0.4 | 0.3 | 0.4 | 0.4 |
| 80 | 0.2 | 0.1 | 0.2 | 0.1 |

% CS = compressive stress-strain

1. An inflatable cellular cushioning article comprising:
a first film sealed to itself or to a second film to create a plurality of inflatable chambers with each chamber comprising a plurality of inflatable cells connected in series with one another by connecting channels;
wherein the first film comprises a plurality of microlayers, with at least 50 percent of the microlayers comprising a polymer selected from the group consisting of ethylene homopolymer, ethylene copolymer, propylene homopolymer, and propylene copolymer; and
wherein the second film comprises a plurality of microlayers with at least 50% of the microlayers in the second film comprising a polymer selected from the group consisting of ethylene homopolymer, ethylene copolymer, propylene homopolymer, and propylene copolymer.

2. The inflatable cellular cushioning article according to claim 1, wherein:
the first film further comprises an alpha section containing a first subset of the plurality of microlayers, and a beta section containing a second subset of the plurality of microlayers, wherein at least 50% of the microlayers in the alpha section comprise a polymer selected from the group consisting of ethylene homopolymer, ethylene copolymer, propylene homopolymer, and propylene copolymer, and at least 50% of the microlayers in the beta section comprise a polymer selected from the group consisting of ethylene homopolymer, ethylene copolymer, propylene homopolymer, and propylene copolymer; and
the second film further comprises a gamma section containing a first subset of the plurality of microlayers in the second film, and a delta section containing a second subset of the plurality of microlayers in the second film, with at least 50% of the microlayers in the gamma section comprising a polymer selected from the group consisting of ethylene homopolymer, ethylene copolymer, propylene homopolymer, and propylene copolymer, and at least 50% of the microlayers in the delta section comprising a polymer selected from the group consisting of ethylene homopolymer, ethylene copolymer, propylene homopolymer, and propylene copolymer.

3. The inflatable cellular cushioning article according to claim 2, wherein:
100% of the microlayers in the alpha section comprise a polymer selected from the group consisting of ethylene homopolymer, ethylene copolymer, propylene homopolymer, and propylene copolymer,
100% of the microlayers in the beta section comprise a polymer selected from the group consisting of ethylene homopolymer, ethylene copolymer, propylene homopolymer, and propylene copolymer,
100% of the microlayers in the gamma section comprise a polymer selected from the group consisting of ethylene homopolymer, ethylene copolymer, propylene homopolymer, and propylene copolymer, and
100% of the microlayers in the delta section comprise a polymer selected from the group consisting of ethylene homopolymer, ethylene copolymer, propylene homopolymer, and propylene copolymer.

4.-6. (canceled)

7. The inflatable cellular cushioning article according to claim 2, wherein the first film comprises from 5 to 200 microlayers and the second film comprises from 5 to 200 microlayers.

8. The inflatable cellular cushioning article according to claim 7, wherein:
each of the microlayers in the alpha section has an average thickness of from 0.001 to 0.1 mil;
the alpha section has a total thickness of from 0.05 mil to 0.5 mil;
each of the microlayers in the beta section has an average thickness of from 0.001 to 0.1 mils;
the beta section has a total thickness of from 0.05 mil to 0.5 mil.

9. The inflatable cellular cushioning article according to claim 7, wherein:
the alpha and beta sections each have from 5 to 50 microlayers and together make up from 20 to 80 wt % of the first film;
the gamma and delta sections each have from 5 to 50 microlayers and together make up from 20 to 80 wt % of the second film; and
each of the microlayers in the alpha, beta, gamma, and delta sections comprise at least one member selected from the group consisting of homogeneous ethylene/alpha-olefin copolymer, low density polyethylene, linear low density polyethylene, very low density polyethylene, ultra low density polyethylene, medium density polyethylene, high density polyethylene, and ethylene/norbornene copolymer.

10. The inflatable cellular cushioning article according to claim 9, wherein:
the alpha and beta sections each have from 10 to 30 microlayers and together make up from 30 to 75 wt % of the first film; and
the gamma and delta sections each have from 10 to 30 microlayers and together make up from 30 to 75 wt % of the second film.

11.-14. (canceled)

15. The inflatable cellular cushioning article according to claim 7, wherein:
the first film further comprises:
an outer seal layer;
an outer abuse layer;
an oxygen barrier layer between the outer seal layer and the outer abuse layer;
a first tie layer between the seal layer and the oxygen barrier layer; and
a second tie layer between the oxygen barrier layer and the abuse layer, wherein the alpha section is between the seal layer and the first tie layer; and
the second film further comprises:
an outer seal layer;
an outer abuse layer;
an oxygen barrier layer between the outer seal layer and the outer abuse layer;
a first tie layer between the seal layer and the oxygen barrier layer; and
a second tie layer between the oxygen barrier layer and the abuse layer, wherein the gamma section is between the seal layer and the first tie layer.

16.-19. (canceled)

20. The inflatable cellular cushioning article according to claim 1, wherein:
the first film has a total thickness of from 0.2 to 1.2 mils; and
the second film has a thickness of from 0.2 to 1.2 mils.

21. (canceled)

22. The inflatable cellular cushioning article according to claim 1, wherein:
the first film has a total thickness of from 0.3 to 1 mil; and
the second film has a thickness of from 0.3 to 1 mil.

23. The inflatable cellular cushioning article according to claim 1, wherein the first film and the second film each have a polyamide content of from 3 to 40 wt % on a total film weight basis.

24. (canceled)

25. The inflatable cushioning article according to claim 1, wherein the first film has a total thickness of from 0.3 mil to 0.5 mil.

26.-28. (canceled)

29. The inflatable cellular cushioning article according to claim 1, wherein:
the chambers extend transversely across the article; and
the chambers extend from an inflation manifold which extends along a machine direction.

30. The inflatable cellular cushioning article according to claim 1, wherein:
the chambers extend transversely across the article; and
the chambers extend from an open skirt which extends along a machine direction.

31. The inflatable cellular cushioning article according to claim 1, wherein each chamber comprises from 3 to 40 cells.

32. The inflatable cellular cushioning article according to claim 1, wherein the cells have a major uninflated lay-flat dimension which has a length of from 8 millimeters to 80 millimeters.

33.-37. (canceled)

38. The inflatable cushioning article of claim 1 wherein the article is inflated.

39. The inflatable cushioning article of claim 1 wherein the article is inflated above ambient pressure. ¶00129

40. The inflatable cushioning article of claim 8 wherein the article is inflated above ambient pressure.

41. The inflatable cushioning article of claim 9 wherein the article is inflated above ambient pressure.
